(19) United States
(12) Patent Application Publication
(10) Pub. No.: US 2024/0370771 A1
(43) Pub. Date: Nov. 7, 2024

(54) METHODS AND APPARATUSES FOR INTELLIGENTLY DETERMINING AND IMPLEMENTING DISTINCT ROUTINES FOR ENTITIES

(71) Applicant: The Strategic Coach Inc., Toronto (CA)

(72) Inventors: Barbara Sue Smith, Toronto (CA); Daniel J. Sullivan, Toronto (CA)

(73) Assignee: The Strategic Coach Inc., Toronto, ON (CA)

(21) Appl. No.: 18/617,159

(22) Filed: Mar. 26, 2024

Related U.S. Application Data
(63) Continuation-in-part of application No. 18/142,748, filed on May 3, 2023, now Pat. No. 11,972,296.

(51) Int. Cl. G06N 20/00; G06F 9/451

(52) U.S. Cl. CPC G06N 20/00; G06F 9/451

(57) ABSTRACT

Methods and apparatuses for intelligently determining and implementing distinct routines for entities are provided. An apparatus includes at least a processor and a memory communicatively coupled to the at least a processor, the memory containing instructions configuring the at least a processor to receive entity data associated with an entity, generate at least one distinct routine for the entity as a function of the entity data., generate a functional model as a function of the at least one distinct routine, and generate a user interface data structure configured to display and including the at least one distinct routine and the functional model. A graphical user interface (GUI) is communicatively connected to the processor and is configured to receive the user interface data structure and display the at least one distinct routine on a first portion of the GUI.

### CROSS-REFERENCE TO RELATED APPLICATIONS

This application is a continuation-in-part of Non-provisional application Ser. No. 18/142,748, filed on May 3, 2023, and entitled “METHODS AND APPARATUSES FOR INTELLIGENTLY DETERMINING AND IMPLEMENTING DISTINCT ROUTINES FOR ENTITIES,” the entirety of which is incorporated herein by reference.

### FIELD OF THE INVENTION

The present invention generally relates to the field of artificial intelligence. In particular, the present invention is directed to methods and apparatuses for intelligently determining and implementing distinct routines for entities.

### BACKGROUND

Automated systems for identification and allocation of distinct processes typically fail to perform such allocations in an efficient manner. This leads to waste in computation resources as well as real-world resources.

### SUMMARY OF THE DISCLOSURE

In an aspect, an apparatus for intelligently determining and implementing distinct routines for entities is disclosed. The apparatus includes at least a processor, a memory communicatively coupled to the at least a processor, the memory containing instructions configuring the at least a processor to receive entity data associated with an entity, generate at least one distinct routine for the entity as a function of the entity data, generate a functional model as a function of the at least one distinct routine, generate a distinct name as a function of the entity data, wherein generating the distinct name includes identifying a plurality of attributes of the entity data, determining a component word set as a function of the plurality of attributes and generating the distinct name as a function of the component word set and generate a user interface data structure comprising the at least one distinct routine, the functional model, and the distinct name and a graphical user interface (GUI) communicatively connected to the at least a processor, the GUI configured to receive the user interface data structure and display the user interface data structure on the GUI.

In another aspect, a method for intelligently determining and implementing distinct routines for entities is disclosed. The method includes receiving, using at least a processor, entity data associated with an entity, generating, using the at least a processor, at least one distinct routine for the entity as a function of the entity data, generating, using the at least a processor, a functional model as a function of the at least one distinct routine, generating, using the at least a processor, a distinct name as a function of the entity data, wherein generating the distinct name includes identifying a plurality of attributes of the entity data, determining a component word set as a function of the plurality of attributes and generating the distinct name as a function of the component word set, generating, using the at least a processor, a user interface data structure including the at least one distinct routine, the functional model, and the distinct name, receiving, using a graphical user interface (GUI) communicatively connected to the at least a processor, the user interface data structure, and displaying, using the GUI, the user interface data structure on the GUI.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a block diagram of an apparatus for intelligently determining and implementing distinct routines for entities;

FIG. 2 illustrates an exemplary embodiment of a graphical user interface;

FIG. 3 illustrates an exemplary embodiment of a machine-learning module;

FIG. 4 illustrates an exemplary embodiment of a database;

FIG. 5 illustrates a flow diagram of an exemplary method of intelligently determining and implementing distinct routines for entities;

FIG. 6 illustrates a schematic diagram of an exemplary embodiment of a fuzzy inferencing system;

FIG. 7 illustrates another exemplary embodiment of a graphical user interface;

FIG. 8 illustrates an exemplary neural network;

FIG. 9 illustrates an exemplary node;

FIG. 10 illustrates a flow diagram of another exemplary method of intelligently determining and implementing distinct routines for entities; and

FIG. 11 illustrates a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to methods and apparatuses for intelligently determining and implementing distinct routines for entities. A further aspect of the present disclosure provides a tailored, interactive graphical user interface (GUI) presented to a user, decision maker, and the like associated with an entity. Information displayed by the apparatus in the GUI, including at least one distinct routine and a functional model, allows the decision maker to efficiently and in a structured manner review data associated with the entity. Aspects of the current disclosure allow for efficient and accurate identification of distinct routines associated with an entity. Exemplary embodiments illustrating aspects of the present disclosure are described below in the context of several specific examples.

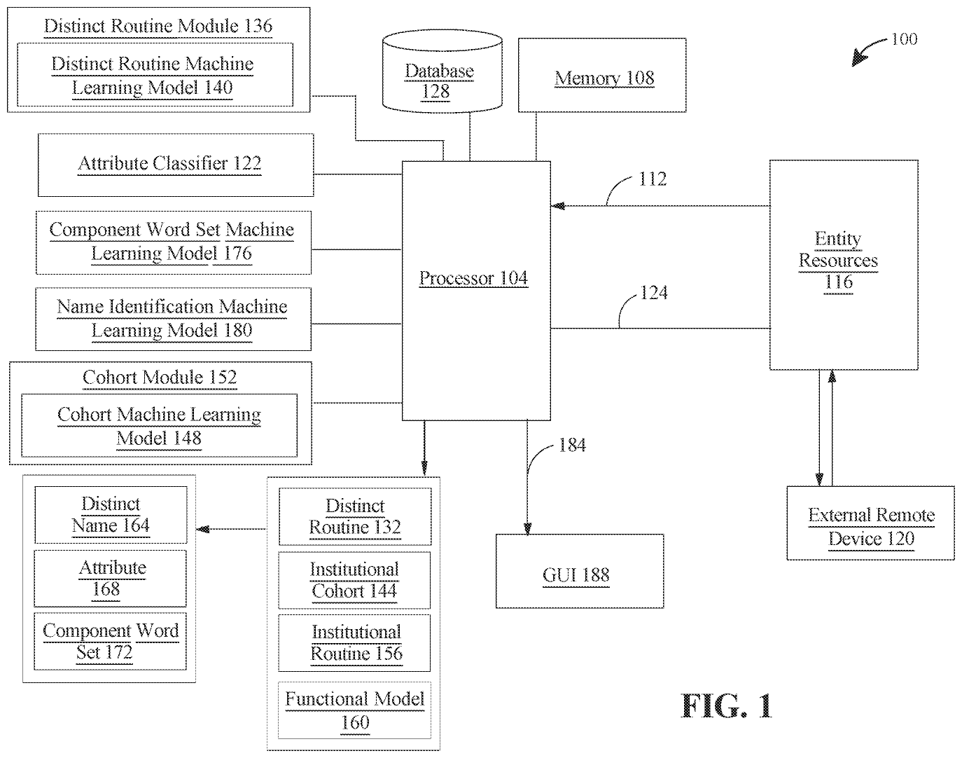

Referring now to FIG. 1, an exemplary embodiment of an apparatus 100 for intelligently determining and implementing distinct routines for entities is illustrated. Apparatus includes a processor 104. Processor 104 may include, without limitation, any processor described in this disclosure. Processor 104 may be included in a computing device. Processor 104 may include any computing device as described in this disclosure, including without limitation a microcontroller, microprocessor, digital signal processor (DSP) and/or system on a chip (SoC) as described in this disclosure. Processor 104 may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented, as a non-limiting example, using a “shared nothing” architecture.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, processor 104 and/or computing device may perform determinations, classification, and/or analysis steps, methods, processes, or the like as described in this disclosure using machine learning processes. A “machine learning process,” as used in this disclosure, is a process that automatedly uses a body of data known as “training data” and/or a “training set” (described further below) to generate an algorithm that will be performed by a computing device/module to produce outputs given data provided as inputs; this is in contrast to a non-machine learning software program where the commands to be executed are determined in advance by a user and written in a programming language. Machine-learning process may utilize supervised, unsupervised, lazy-learning processes and/or neural networks, described further below.

Continuing to reference to FIG. 1, a computing device and/or apparatus 100 includes a memory 108 and at least a processor 104. Memory 108 may include any memory as described in this disclosure. Memory 108 is communicatively connected to processor 104. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. Memory 108 may be configured to provide instructions to processor 104, which may include any processor as described in this disclosure.

With continued reference to FIG. 1, processor 104 may further comprise and/or be included in a server. A server may include a computing device and/or a plurality of computing devices that provide functionality for other programs or devices. A server may provide various functionalities such as sharing data or resources and performing computation among multiple other programs and or devices. Servers may include database servers, file servers, mail servers, print servers, web servers, and/or application servers. In an embodiment, the server may communicate with processor 104 through a communication network. A communication network may include a network interface card (e.g., a mobile network interface card, a LAN card), a modem, and any combination thereof. A communication network may also include a wide area network (e.g., the Internet, an enterprise network), a local area network (e.g., a network associated with an office, a building, a campus or other relatively small geographic space), a telephone network, a data network associated with a telephone/voice provider (e.g., a mobile communication provider data and/or voice network), a direct connection between two computing devices, and any combination thereof. A communication network may employ a wired and/or wireless mode of communication. In general, any network topology may be used. Information may be communicated to and/or from processor 104 through a communication network.

Still referencing FIG. 1, processor 104 is configured to receive entity data 112 associated with an entity. “Entity data,” as used in this disclosure, is any data and/or information about an entity or entity resources 116 and any activity engaged in by the entity and entity resources 116. As used in this disclosure, an “entity” is an organized body of people or resources. In a nonlimiting embodiment, an entity may be a company, business, and the like. As used in this disclosure, an “entity resources” is an asset that can be used by an organization to perform actions or conduct activity. In an embodiment, entity resources 116 may include an entity network, entity digital resources, and/or entity staff. As used in this disclosure, “entity network” is an integrated communications environment where digital devices communicate and manage data and interactions to and/or from an entity. In an exemplary embodiment, entity data 112 for an entity network may include data about a computer network and network interaction data between the entity network and at least one external remote device 120. As used in this disclosure, “network interaction data” is any data or information about activities to and from entity network and any external remote device. In an exemplary embodiment, network interaction data may include communications from entity network, user interactions with entity network, and the like. As used in this disclosure, “external remote device” is a computing device that is external to the entity and communicates with the entity through the entity network. In an exemplary embodiment, entity data 112 may include activity data communicated to and/or from entity resources to the at least one external remote device 120. As used in this disclosure, “activity data” is information about actions, processes, and the like provided to the at least one external remote device 120. Further, as used in this disclosure, an “entity digital resource” is any software that makes up the entity network as well as any software or device that can be accessed from the entity network. In addition, “entity staff” is any personnel and/or staff resources associated with the entity. In an exemplary embodiment, entity data 112 for entity staff may include staff role data, staff activity data, and the like. As used in this disclosure, “staff role data” is data about a current role and/or position entity staff may hold within an entity. Further, “staff activity data,” as used in this disclosure, is data about activities conducted by entity staff within and/or external to the entity.

With continued reference to FIG. 1, in some embodiments, processor 104 may receive entity data 112 from an entity data source. Entity data 112 may include, in non-limiting examples, a description of the entity, social media discussions of the entity, audit reports discussing the entity, job descriptions of entity employees, resumes of entity employees, and financial reports discussing the entity. In some embodiments, an entity data source may include a computing device such as a smartphone, tablet, or computer, which accepts human data input. An entity data source may include, without limitation, one or more of a device capable of receiving audio information, a device capable of receiving visual information, a device capable of receiving manual user input, or a device capable of digitizing physical documents. An entity data source may include, without limitation, one or more of a microphone, camera, keyboard, computer mouse, smartphone, controller, touchscreen, button, switch, or scanner. In some embodiments, an entity data source may include a display, such as a screen. In some embodiments, an entity data source may include a graphical user interface. In some embodiments, entity data 112 may be retrieved from database. As a non-limiting example, processor 104 may request entity data 112 from an application programming interface (API) associated with a database and may receive entity data 112 from a computing device associated with the database.

With continued reference to FIG. 1, in some embodiments, an entity data source may include a web crawler or may store entity data 112 obtained using a web crawler. A web crawler may be configured to automatically search and collect information related to a user. A “web crawler,” as used herein, is a program that systematically browses the internet for the purpose of web indexing. The web crawler may be seeded with platform URLs, wherein the crawler may then visit the next related URL, retrieve the content, index the content, and/or measures the relevance of the content to the topic of interest. In one embodiment, the web crawler may be configured to scrape entity data 112 from entity related social media and networking platforms. The web crawler may be trained with information received from an entity through a digital interface. As a non-limiting example, an entity employee may input into a digital interface, social media platforms the entity has accounts on and would like to retrieve entity data 112 from. A digital interface may include a graphical user interface (GUI), command line interface (CLI), menu-driven user interface, touch user interface, voice user interface (VUI), form-based user interface, and the like. Processor 104 may receive entity data 112 including information such as an entity's name, profile, platform handles, platforms associated with the entity, descriptions of activities undertaken by entity, descriptions of products or services offered by entity, descriptions of achievements of entity employees, profiles of entity employees, business partners associated with entity, and the like. In some embodiments, a web crawler may be configured to generate a web query. A web query may include search criteria. Search criteria may include entity account handles, employee account handles, web page addresses and the like received from the entity. A web crawler function may be configured to search for and/or detect one or more data patterns. A “data pattern” as used in this disclosure is any repeating forms of information. A data pattern may include, but is not limited to, features, phrases, and the like as described further below in this disclosure. The web crawler may work in tandem with a machine-learning model, digital processing technique utilized by a processor, and the like as described in this disclosure. In some embodiments, a web crawler may be configured to determine the relevancy of a data pattern. Relevancy may be determined by a relevancy score. A relevancy score may be automatically generated by processor 104, received from a machine learning model, and/or received from the user. In some embodiments, a relevancy score may include a range of numerical values that may correspond to a relevancy strength of data received from a web crawler function. As a non-limiting example, a web crawler function may search the Internet for data related to entity employees. In some embodiments, computing device may determine a relevancy score of entity data 112 retrieved by a web crawler.

With continued reference to FIG. 1, in some embodiments, entity data 112 may include image data, which may be processed using optical character recognition or optical character reader technology. In some embodiments, optical character recognition or optical character reader (OCR) includes automatic conversion of images of written (e.g., typed, handwritten or printed text) into machine-encoded text. In some cases, recognition of at least a keyword from image data may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine-learning processes. In some cases, intelligent word recognition (IWR) may recognize written text, one word at a time, for instance by employing machine-learning processes.

With continued reference to FIG. 1, in some cases OCR may be an “offline” process, which analyses a static document or image frame. In some cases, handwriting movement analysis can be used as input to handwriting recognition. For example, instead of merely using shapes of glyphs and words, this technique may capture motions, such as the order in which segments are drawn, the direction, and the pattern of putting the pen down and lifting it. This additional information may make handwriting recognition more accurate. In some cases, this technology may be referred to as “online” character recognition, dynamic character recognition, real-time character recognition, and intelligent character recognition.

With continued reference to FIG. 1, in some cases, OCR processes may employ pre-processing of image data. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image data to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image data. In some cases, binarization may be required for example if an employed OCR algorithm only works on binary images. In some cases, a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image data.

With continued reference to FIG. 1, in some embodiments an OCR process may include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of image data. Matrix matching may also rely on a stored glyph being in a similar font and at a same scale as input glyph. Matrix matching may work best with typewritten text.

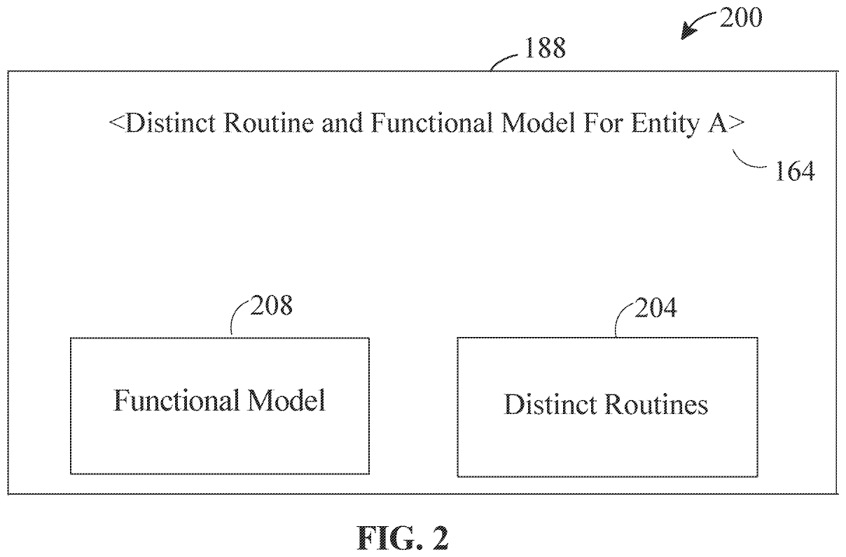

With continued reference to FIG. 1, in some embodiments, an OCR process may include a feature extraction process. In some cases, feature extraction may decompose a glyph into at least a feature. Exemplary non-limiting features may include corners, edges, lines, closed loops, line direction, line intersections, and the like. In some cases, feature extraction may reduce dimensionality of representation and may make the recognition process computationally more efficient. In some cases, extracted feature may be compared with an abstract vector-like representation of a character, which might reduce to one or more glyph prototypes. General techniques of feature detection in computer vision are applicable to this type of OCR. In some embodiments, machine-learning processes like nearest neighbor classifiers (e.g., k-nearest neighbors algorithm) may be used to compare image features with stored glyph features and choose a nearest match. OCR may employ any machine-learning process described in this disclosure, for example machine-learning processes described with reference to FIGS. 2-4. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

With continued reference to FIG. 1, in some cases, OCR may employ a two-pass approach to character recognition. A first pass may try to recognize a character. Each character that is satisfactory is passed to an adaptive classifier as training data. The adaptive classifier then gets a chance to recognize characters more accurately as it further analyzes image data. Since the adaptive classifier may have learned something useful a little too late to recognize characters on the first pass, a second pass is run over the image data. Second pass may include adaptive recognition and use characters recognized with high confidence on the first pass to recognize better remaining characters on the second pass. In some cases, two-pass approach may be advantageous for unusual fonts or low-quality image data. Another exemplary OCR software tool include OCRopus. OCRopus development is led by German Research Centre for Artificial Intelligence in Kaiserslautern, Germany. In some cases, OCR software may employ neural networks.

With continued reference to FIG. 1, in some cases, OCR may include post-processing. For example, OCR accuracy may be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of image data. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, in some embodiments, OCR may be used to convert entity data 112 in the form of image files to text files. In a non-limiting example, OCR may be used to produce a text file from an image or PDF of a description of skills of particular employees. Entity data 112 converted to text using OCR may then be interpreted or modified by a language model. The language model is further described below. Entity data 112 converted to text using OCR may be input into attribute classifier 122. The attribute classifier 122 is further described below. As a non-limiting example, attribute classifier 122 may only accept inputs in a text format, and entity data 112 may be converted into that format such that it may be effectively input into attribute classifier 122.

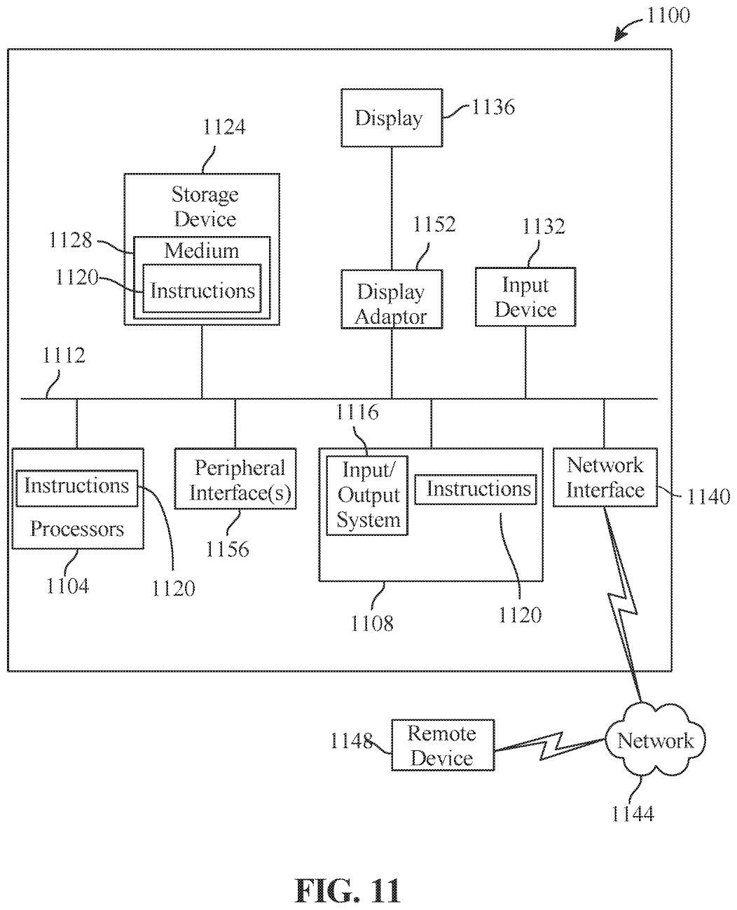

With continued reference to FIG. 1, entity resources may also include any software or digital device that can be accessed from that computer system and/or entity network. Digital device, as described above, may be any computing device as described in this disclosure, for example as described in FIG. 11. For example, the entity network may be one of a computer system, computer network, and the like. In an exemplary embodiment, the organizational network may include a plurality of user devices. A “user device,” for the purpose of this disclosure, is any additional computing device, such as a mobile device, laptop, desktop computer, or the like. In a non-limiting embodiment, user device may be a computer and/or smart phone operated by a user in a remote location. User device may include, without limitation, a display; the display may include any display as described in the entirety of this disclosure such as a light emitting diode (LED) screen, liquid crystal display (LCD), organic LED, cathode ray tube (CRT), touch screen, or any combination thereof. In a non-limiting embodiment, user device may include a graphical user interface (GUI) configured to display any information from apparatus 100 and/or any computing device. In some embodiments, the entity network may also include any electronic asset associated with the entity and connected to the entity network, as described in more detail below. For example, electronic assets may be computer programs, data, data stores, and the like, but are not limited to such examples. The organizational network may be connected to processor 104 by a network 124, as described in more detail above.

Continuing to reference FIG. 1, receiving the entity data 112 may include receiving a user input that may include the entity data 112. As used in this disclosure, a “user input,” as used in this disclosure, is a form of data entry received from an individual and/or group of individuals, such as an individual and/or group of individuals that is using and/or interacting with apparatus 100. In an embodiment, the user input may be received from one or more of the entity staff associated with the entity. For example, user input may be received from a client interface staff, entity executive, and the like. In some cases, user input may include selecting a selection from plurality of selections as an answer. In other cases, user input may include a free user input as an answer to a user prompt. Additionally, or alternatively, the user input may include a plurality of entity activity data. As used in this disclosure, “entity activity data” is data about the activities conducted by the entity and entity resources. For example, entity activity data may include communications from the entity and/or entity resources, types of communications, services offered, user experience offered, and the like. In an exemplary embodiment, entity data 112 may be in various formats such as, without limitation, txt file, JSON file, word document, pdf file, excel sheet, image, video, audio, and the like.

With continued reference to FIG. 1, additionally, or alternatively, receiving the entity data 112 may include automatedly surveying the plurality of entity resources. As used in this disclosure, “automatedly surveying” is scanning the entity network to collect information on activities conducted by entity resources connected to an entity. In a non-limiting example, automatedly surveying may include extracting data from entity resources, such as activity data of entity resources. Additionally, or alternatively, automatedly surveying the plurality of organizational resources may include connecting to an entity network and collecting activity data for the entity resources. In an embodiment, processor 104 may be configured to collect activity data for entity resources and store the activity data in a database, for example database 128. For example, processor 104 may be configured to monitor activities of the entity resources using the connection to the entity network and processor 104 may be configured to generate activity databased on the monitoring of activities within the entity network.

Continuing to refer to FIG. 1, processor 104 is further configured to generate at least one distinct routine 132 for the entity as a function of the entity data 112. As used in this disclosure, “distinct routine” is an established practice implemented by the entity. For example, the at least one distinct routine may be any combination of a unique experience, a unique method, a unique characteristic, and the like offered by the entity. In an embodiment, the at least one distinct routine may be determined from the entity data 112. In an exemplary embodiment, the at least one distinct routine 132 may be determined based on a frequency of occurrence of a particular routine within the entity data 112. In such an embodiment, processor 104 may be configured to determine a frequency of occurrence for each of a plurality of candidate routines. Further, processor 104 may be configured to compare the frequency of occurrence for each of the plurality of candidate routines to a threshold frequency and select at least one of the plurality of candidate routines as one distinct routine 132 based on comparing the frequency of occurrence and the threshold frequency.

Continuing to reference FIG. 1, processor 104 may use a machine learning module, such as distinct routine module 136, to implement one or more algorithms or generate one or more machine-learning models, such as distinct routine machine learning model 140, to generate the at least one distinct routine. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories of data elements. Exemplary inputs and outputs may come from a database, such as any database described in this disclosure, or be provided by a user. In other embodiments, a machine-learning module may obtain a training set by querying a communicatively connected database that includes past inputs and outputs. Training data may include inputs from various types of databases, resources, and/or user inputs and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements.

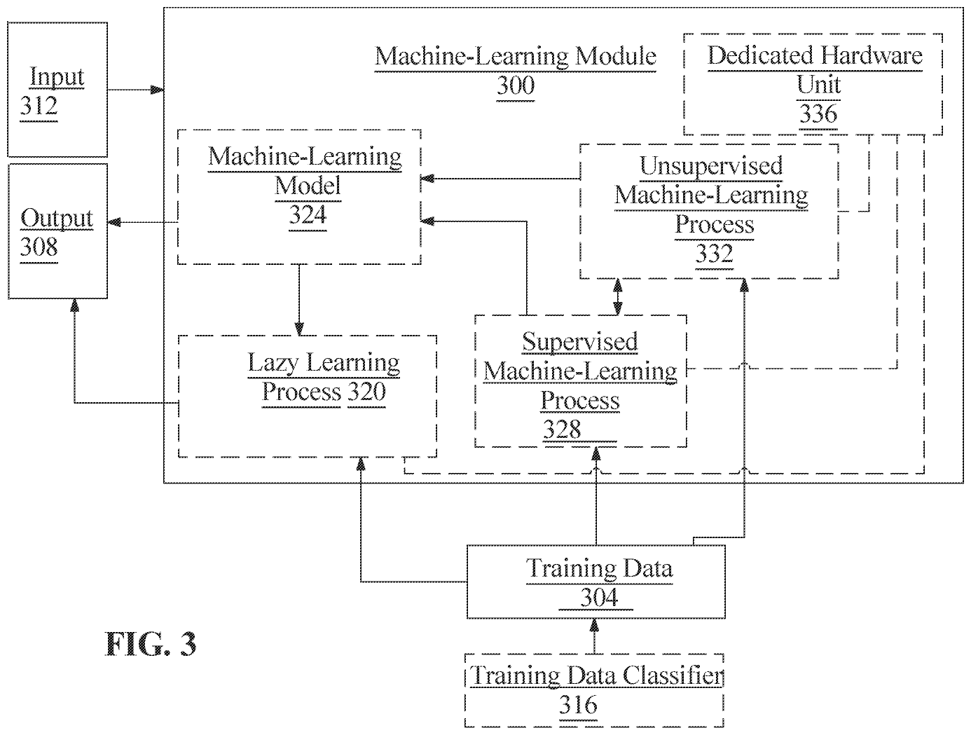

With continued reference to FIG. 1, in some embodiments, distinct routine module 136 may be used to generate distinct routine machine learning model 140 and/or any other machine learning model using distinct routine training data. Distinct routine machine learning model 140 May be trained by correlated inputs and outputs of distinct routine training data. Distinct routine training data may be data sets that have already been converted from raw data whether manually, by machine, or any other method. Distinct routine training data may include previous outputs such that distinct routine machine learning model 140 iteratively produces outputs. Distinct routine machine learning model 140, using a machine-learning process, may output converted databased on input of training data. In some embodiments, processor 104 may generate distinct routine training data. In a non-limiting example, distinct routine training data may include correlations between exemplary entity data and exemplary distinct routine. In some embodiments, distinct routine training data may be stored in database 128. In some embodiments, distinct routine training data may be received from one or more users, database 128, external computing devices, and/or previous iterations of processing. As a non-limiting example, distinct routine training data may include instructions from a user, who may be an expert user, a past user in embodiments disclosed herein, or the like, which may be stored in memory and/or stored in database 128, where the instructions may include labeling of training examples. In some embodiments, distinct routine training data may be updated iteratively on a feedback loop. As a non-limiting example, processor 104 may update distinct routine training data iteratively through a feedback loop as a function of entity data 112, or the like. In some embodiments, processor 104 may be configured to generate distinct routine machine learning model 140. In a non-limiting example, generating distinct routine machine learning model 140 may include training, retraining, or fine-tuning distinct routine machine learning model 140 using distinct routine training data or updated distinct routine training data. In some embodiments, processor 104 may be configured to distinct routine 132 using distinct routine machine learning model 140 (i.e. trained or updated distinct routine machine learning model 140). In some embodiments, entity or entity data 112 may be classified to entity cohort and processor 104 may determine candidate name based on the entity cohort using a machine-learning module as described in detail with respect to FIG. 3 and the resulting output may be used to update distinct routine training data. In some embodiments, generating training data and training machine-learning models may be simultaneous.

Continuing to reference FIG. 1, in an embodiment, processor 104 may be configured to determine at least one distinct routine 132 using a machine learning model, such as distinct routine machine learning model 140 generated by distinct routine module 136. Distinct routine machine learning model 140 may be trained by training data, discussed in further detail below, such as distinct routine training data. Distinct routine training data may be stored in database 128.

With continued reference to FIG. 1, determining the distinct routine 132 using a machine learning model may include receiving distinct routine training data. In an embodiment, distinct routine training data may include entity data 112 correlated to distinct routine 132. For example, distinct routine training data may be used to show entity data 112 may indicate a particular distinct routine 132. In an exemplary embodiment, a distinct routine 132 may be a unique experience, a unique method, a unique characteristic, and the like. In a further embodiment, distinct routine training data may also include a plurality of entity data 112 that are each correlated to at least one distinct routine 132 of a plurality of distinct routines 132. In such an embodiment, distinct routine training data may be used to show how entity data 112 may indicate particular distinct routines. Determining distinct routine 132 using a machine learning model may further include training a distinct routine machine learning model 140 as a function of distinct routine training data. Further, determining distinct routine 132 using a machine learning model may also include generating the at least one distinct routine 132 using the trained distinct routine machine learning model 140.

With continued reference to FIG. 1, generating the at least one distinct routine comprises identifying at least one institutional cohort 144 to the entity. As used in this disclosure, “institutional cohort” is a secondary organization with similar characteristics to the entity such as size, organization, area of operation, goals, and the like. In an embodiment, processor 104 may be configured to receive a user input comprising the at least one institutional cohort 144. In an embodiment, the user input may be received from one or more of the entity staff associated with the entity. For example, user input may be received from a client interface staff, entity executive, and the like. In some cases, user input may include selecting a selection from plurality of selections as an answer. In other cases, user input may include a free user input as an answer to a user prompt.

Continuing to refer to FIG. 1, in an embodiment, processor 104 may be configured to identify at least one institutional cohort 144 using a machine learning model, such as cohort machine learning model 148 generated by cohort module 152. Cohort machine learning model 148 may be trained by training data, discussed in further detail below, such as institutional cohort training data. Institutional cohort training data may be stored in database 128.

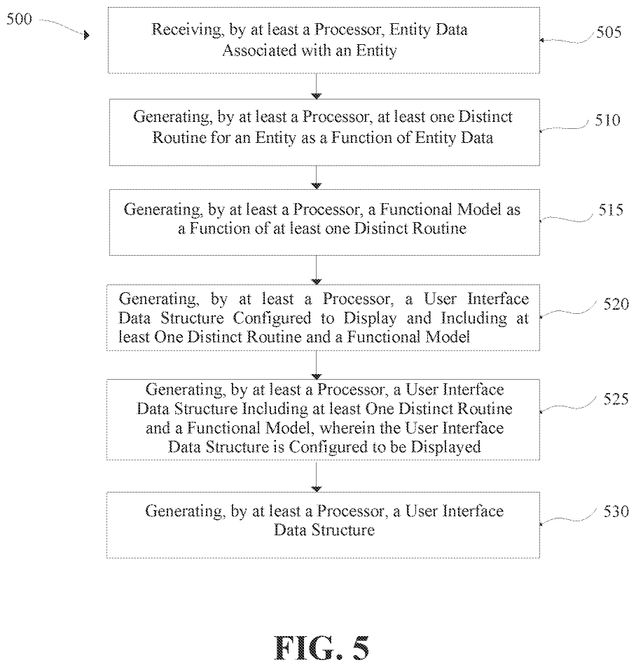

With continued reference to FIG. 1, identifying the at least one institutional cohort using a machine learning model may include receiving institutional cohort training data. In an embodiment, institutional cohort training data may include entity data 112 that are correlated to institutional cohort data. For example, institutional cohort training data may be used to show entity data 112 may indicate a particular institutional cohort. In an exemplary embodiment, an institutional cohort may be a competing entity with a similar area of operation, organization, market, and the like. In a further embodiment, institutional cohort training data may also include a plurality of entity data 112 that are each correlated to at least one institutional cohort of a plurality of institutional cohorts. In such an embodiment, institutional cohort training data may be used to show how entity data 112 may indicate particular institutional cohorts. Identifying the at least one institutional cohort using a machine learning model may further include training a cohort machine learning model 148 as a function of the institutional cohort training data. Further, identifying the at least one institutional cohort using a machine learning model may also include generating the at least one institutional cohort 144 using the trained cohort machine learning model 148. Alternatively, or additionally, a fuzzy inferencing system for identifying the at least one institutional cohort may be employed, where any or all institutional cohorts may be represented as values and/or fuzzy sets for linguistic variables measuring the same, as described in more detail in FIG. 5. An inferencing system may use one or more fuzzy inferencing rules, as described below in FIG. 5, to output one or more linguistic variable values and/or defuzzified values indicating a plurality of institutional cohorts. Further, alternatively, or additionally, a classifier for identifying the at least one institutional cohort may be employed. In an embodiment, the classifier for identifying the at least one institution cohort may be any classifier describe herein. As a non-limiting example, classifier may be trained using training data including entity data 112 correlated to one or more institutional cohorts.

With continued reference to FIG. 1, generating the at least one distinct routine comprises detecting at least one institutional routine 156 of the institutional cohort 144. As used in this disclosure, “institutional routine” is an established practice implemented by the institutional cohort. For example, the at least one institutional routine may include an experience offered by the institutional cohort, a method used by the institutional cohort, and the like. In an embodiment, detecting the at least one institutional routine 156 of the institutional cohort 144 may comprise receiving institutional cohort data associated with each identified institutional cohort 144. “Institutional cohort data,” as used in this disclosure is any data and/or information about an institutional cohort and any activity engaged in by the institutional cohort 144.

With continued reference to FIG. 1, in some embodiments, institutional cohort data may be derived from a web crawler. A “web crawler,” as used herein, is a program that systematically browses the internet for the purpose of Web indexing. The web crawler may be seeded with platform URLs, wherein the crawler may then visit the next related URL, retrieve the content, index the content, and/or measures the relevance of the content to the topic of interest. In some embodiments, processor 104 may generate a web crawler to scrape institutional cohort data from a plurality of social media sites, blogs, or forums, review sites, and the like in a virtual environment, such as the Internet. The web crawler may be seeded and/or trained with a reputable website, such as an institutional cohort website, to begin the search. A web crawler may be generated by a processor 104. In some embodiments, the web crawler may be trained with information received from an external user through a user interface. In some embodiments, the web crawler may be configured to generate a web query. A web query may include search criteria received from a user. For example, and without limitation, a user may submit a plurality of websites for the web crawler to search for institutional cohort data. Additionally, the web crawler function may be configured to search for and/or detect one or more data patterns. A “data pattern” as used in this disclosure is any repeating forms of information. A data pattern may include repeating institutional routines and the like. In some embodiments, the web crawler may be configured to determine the relevancy of a data pattern. Relevancy may be determined by a relevancy score. A relevancy score may be automatically generated by processor 104, received from a machine learning model, and/or received from the user. In some embodiments, a relevancy score may include a range of numerical values that may correspond to a relevancy strength of data received from a web crawler function. As a non-limiting example, a web crawler function may search the Internet within virtual environment for institutional cohort data related to the institutional cohort 144. The web crawler may return institutional cohort data, such as, as non-limiting examples, virtual activity data, and the like.

Continuing to reference FIG. 1, in an embodiment, processor 104 may be configured to determine at least one institutional routine 156 using a machine learning model, such as institutional routine machine learning model generated by institutional routine module. Institutional routine machine learning model may be trained by training data, discussed in further detail below, such as institutional routine training data. Institutional routine training data may be stored in database 128.

With continued reference to FIG. 1, determining the at least one institutional routine 156 using a machine learning model may include receiving institutional routine training data. In an embodiment, institutional routine training data may include institutional cohort data that are correlated to institutional routine data. For example, institutional routine training data may be used to show institutional cohort data may indicate a particular institutional routine. In an exemplary embodiment, an institutional routine may be an experience provided by institutional cohort, a characteristic associated with the institutional cohort, and the like. In a further embodiment, institutional routine training data may also include a plurality of institutional cohort data that are each correlated to at least one institutional routine of a plurality of institutional routines. In such an embodiment, institutional routine training data may be used to show how institutional cohort data may indicate particular institutional routines. Determining the at least one institutional routine using a machine learning model may further include training an institutional routine machine learning model as a function of institutional routine training data. Further, determining the at least one institutional routine using a machine learning model may also include generating the at least one institutional routine 156 using the trained institutional routine machine learning model.

With further reference to FIG. 1, generating the at least one distinct routine 132 comprises determining the at least one distinct routine 132 as a function of the at least one institutional routine 156. In an embodiment, processor 104 may be configured to determine the at least one distinct routine 132 based on a comparison between the at least one distinct routine 132 and the at least one institutional routine 156. For example, processor 104 may be configured to detect that a distinct routine may not be any of the at least one institutional routines and determine the distinct routine as one of the at least one distinct routine.

Continuing to reference FIG. 1, the determining the at least one distinct routine as a function of the at least one institutional routine may comprise calculating a distance metric between each distinct routine of the at least one distinct routine and each institutional routine of the at least one institutional routine. A “distance metric” as used in this disclosure, is a quantitative value indicating a degree of similarity of a set of data values to another set of data values. In some cases, a distance metric between any two or more metrics, for example each distinct routine of the at least one distinct routine 132 and each institutional routine of the at least one institutional routine 156, may be calculated using any method described in detail below.

With continued reference to FIG. 1, for instance, and without limitation, each distinct routine of the at least one distinct routine and each institutional routine of the at least one institutional routine, may be represented by a vector. Each vector may be represented, without limitation, as an n-tuple of values, where n is at least two values. Each value of n-tuple of values may represent a measurement or other quantitative value associated with a given category of data, or attribute, such as a distinct routine, examples of which are provided in further detail throughout this disclosure; a vector may be represented, without limitation, in n-dimensional space using an axis per category of value represented in n-tuple of values, such that a vector has a geometric direction characterizing the relative quantities of attributes in the n-tuple as compared to each other. A non-limiting distance may include a degree of vector similarity. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent, for instance as measured using cosine similarity; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values. As a non-limiting illustration, an institutional routine, and/or one or more subsets thereof, may be represented using a vector or other data structure, and a plurality of distinct routines output from one or more machine-learning processes may be represented by a like data structure, such as another vector; a distance comparing the two data structures may then be calculated and compared to distances calculations to find a minimal distance calculation and/or a set of minimal distance calculations. A set of minimal distance calculations may be a set of distance calculations less than a preconfigured threshold distance from data structure representing an institutional routine. Preconfigured threshold may be set by one or more expert users and/or determined statistically.

With continued reference to FIG. 1, distance may be determined using a distance of and/or used in a classifier. A classifier used to compute distance may include, without limitation, a classifier using a K-nearest neighbors (KNN) algorithm. The KNN algorithm disclosed herein further described below.

Continuing to reference FIG. 1, determining at least one distinct routine 132 as a function of at least one institutional routine may include determining at least one distinct routine as a function of distance metric. In an exemplary embodiment, processor 104 may be configured to compare the distance metric for each combination of each distinct routine of the at least one distinct routine and each institutional routine of the at least one institutional routine to a distance threshold. As used in this disclosure, “distance threshold” is a minimum measure of difference between distinct routines and institutional routines indicating a minimum difference to identify a distinct routine as one of the at least one distinct routine 132. For example, when a distance metric between a distinct routine and an institutional routine is greater than the distance threshold, processor 104 may be configured to identify the distinct routine as one of the at least one distinct routine 132. In an embodiment, the distance threshold may be calculated by a machine-learning and/or statistical process, for instance and without limitation as described herein.

With continued reference to FIG. 1, processor 104 is configured to generate a functional model 160 as a function of the at least one distinct routine. As used in this disclosure, “functional model” is a structured representation of an entity's operations that are routinely performed by the entity. In an embodiment, generating the functional model 160 as a function of the at least one distinct routine may comprise combining each distinct routine of the at least one distinct routine 132. For example, processor 104 may be configured to parse each distinct routine of the at least one distinct routine 132 and aggregate each distinct routine 132 into a functional model 160 for the entity.

With continued reference to FIG. 1, generating functional model 160 as a function of at least one distinct routine 132 may include classifying each of at least one distinct routine 132 into a plurality of routine categories as a function of a routine classifier. For example, routine categories may include customer experience, methodology, characteristics, and the like. One skilled in the art will recognize various other types of routine categories that may exist. A classifier may be configured to output at least a datum that labels or otherwise identifies a set of data that are clustered together, found to be close under a distance metric as described below, or the like. Processor 104 and/or another device may generate a classifier using a classification algorithm, defined as a process whereby a processor 104 derives a classifier from training data, such as routine classification training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. Routine classifier may classify distinct routine to one or more types and/or category of routines, which may include any type of routine category, sub-categories and/or more specific categories, or the like. For instance, routine classifier may receive distinct routine data and classify the distinct routine data according to type of distinct routine such as customer experience, methodology, characteristics, or the like. Routine classifier may be trained using training data correlating distinct routine data to a type of distinct routine.

With further reference to FIG. 1, generating functional model 160 as a function of at least one distinct routine 132 may include selecting one distinct routine 132 from each of plurality of routine categories. In an exemplary embodiment, a plurality of distinct routines 132 may be classified into a plurality of categories of distinct routine 132 by the routine classifier and processor 104 may be configured to may be configured to select a distinct routine from each of the plurality of routine categories.

With continued reference to FIG. 1, selecting at least one distinct routine 243 from each of plurality of routine categories may include determining a frequency datum for each of the at least one distinct routine in entity data 112. As used in this disclosure, “frequency datum” is an indicator of a frequency of occurrence of a particular distinct routine in entity data 112. In an embodiment, frequency datum may be an indicator of an importance of distinct routine 132 to the entity. For example, a frequency datum indicating a high frequency may indicate a more common occurrence of the distinct routine and a more central distinct routine for the entity. Processor 104 may be configured to determine a frequency datum for each of the at least one distinct routine and/or each distinct routine within a particular routine category.

Continuing to reference FIG. 1, selecting at least one distinct routine 132 from each of a plurality of routine categories may include comparing frequency datum for each of at least one distinct routine 132. In an exemplary embodiment, processor 104 may be configured to compare frequency datum for each distinct routine 132 of at least one distinct routine 132. For example, processor 104 may be configured to compare a frequency datum associated with one distinct routine with each frequency datum associated with each remaining distinct routine 132 of the at least one distinct routine 132. Additionally, or alternatively, in an embodiment, processor 104 may be configured to compare frequency datum for each distinct routine within a particular routine category. For example, processor 104 may be configured to one distinct routine within a particular routine category with each frequency datum associated with each remaining distinct routine within the particular routine category.

With further reference to FIG. 1, selecting at least one distinct routine 132 from each of plurality of routine categories may include selecting at least one distinct routine 132 as a function of comparing of frequency datum. In an embodiment, processor 104 may be configured to determine a distinct routine 132 with highest frequency datum based on the comparison of each frequency datum for each distinct routine 132 within each routine category of plurality of routine categories.

With continued reference to FIG. 1, generating the functional model as a function of the at least one distinct routine further may include combining each of the selected distinct routines as the functional model. For example, processor 104 may be configured to aggregate each of the selected distinct routines from each routine category of the plurality of routine categories into a functional model 160 for the entity.

With continued reference to FIG. 1, processor 104 is configured to generate a distinct name 164. For the purposes of this disclosure, a “distinct name” is a word or set of words by which a specific person, entity, place, routine, system, concept or thing is referred to. Processor 104 is configured to generate distinct name 164 as a function of entity data 112, distinct routine 132 and functional model 160. As a non-limiting example, processor 104 may determine distinct name 164 for distinct routine 132, functional model 160, entity, or the like. Processor 104 is configured to generate distinct name 164 by identifying a plurality of attributes 168 of entity data 112, distinct routine 132 and functional model 160, determining a component word set 172 as a function of attributes 168 and generating distinct name 164 as a function of component word set 172. In some embodiments, distinct name 164 may be stored in a database 128 and processor 104 may retrieve distinct name 164 from database 128. In some embodiments, user may manually input distinct name 164.

With continued reference to FIG. 1, processor 104 is configured to identify a plurality of attributes 168 as a function of entity data 112, distinct routine 132 and functional model 160. For the purposes of this disclosure, an “attribute” is a feature of a person, entity, place, routine, system, concept or thing. As a non-limiting example, attribute 168 may include personal, physical, geographical, statistical, biological, financial attributes, or the like. For example, and without limitation, attributes 168 may include age, gender, personality traits, skills, shape, texture, size, price, location, revenue, profit, purpose, target, or the like. In a non-limiting example, processor 104 may be configured to identify attributes 168 of entity from entity data 112, attributes 168 of distinct routine 132 and attributes 168 of functional model 160. In some embodiments, a plurality of attributes 168 may be stored in a database and processor 104 may retrieve attributes from the database. In some embodiments, a user may manually input a plurality of attributes 168.

With continued reference to FIG. 1, in some embodiments, processor 104 may identify an attribute cluster. As used herein, an “attribute cluster” is a plurality of related attributes of an entity, distinct routine and functional model. In non-limiting examples, an entity may include a person or a company. An attribute 168 may include any or all of a feature, section, knowledge, asset, or skill of an entity. In non-limiting examples, if an entity is a company, attribute 168 may include a branch of the company or a particular area of expertise of employees of the company. Attribute cluster may include a single attribute 168 of the entity, or it may include more than one attribute 168. Attribute cluster may include multiple related attributes 168. In a non-limiting example, attribute cluster may include knowledge of how to paint and an inventory of paintbrushes. In another non-limiting example, attribute cluster may include knowledge of how to use several computer programs, each useful for an aspect of creating virtual artwork. In another non-limiting example, attribute cluster may include knowledge of how to use a single computer program.

With continued reference to FIG. 1, in some embodiments, processor 104 may identify a plurality of attributes 168 by using attribute classifier 122. Attribute classifier 122 may receive as inputs entity data 112, distinct routine 132 and/or functional model 160 and predetermined attribute list and may output attribute 168. In a non-limiting example, attribute classifier 122 may be trained on a dataset including historical functional model associated with historical attributes. In another non-limiting example, attribute classifier 122 may be trained on a dataset including historical distinct routine 132 associated with historical attributes. In another non-limiting example, attribute classifier 122 may be trained on a dataset including historical entity data associated with historical attributes. As a non-limiting example, attribute classifier 122 may be trained on a dataset including, for each historical entity in the dataset, historical entity data associated with which computer programs employees of that entity had expertise in; attribute classifier 122 trained on such data may be capable of associating entity data 112 with attributes 168, where the attributes 168 include which computer programs employees of the entity have expertise in. As another non-limiting example, attribute classifier 122 may be trained on a dataset including, for each historical entity in the dataset, historical entity data associated with which physical assets such as machines and land that entity possessed; attribute classifier 122 trained on such data may be capable of associating entity data 112 with attributes 168, where the attributes 168 include which physical assets an entity possesses. As another non-limiting example, attribute classifier 122 may be trained on a dataset including, for each historical entity in the dataset, historical entity data associated with which languages employees of that entity spoke; attribute classifier 122 trained on such data may be capable of associating entity data 112 with attributes 168, where the attributes 168 include which languages employees of an entity speak. Entity data may be processed before it is input into attribute classifier 122, such as using optical character recognition, a language model, and/or data type conversions as described below. Attribute classifier 122 may also accept as an input predetermined attribute list and may associate entity data 112 with attributes 168 on the predetermined attribute list.

With continued reference to FIG. 1, in some embodiments, processor 104 may generate attribute training data. In a non-limiting example, attribute training data may include correlations between exemplary entity data and exemplary attributes or attribute clusters. For example, and without limitation, attribute training data may include correlations between entity data 112 and attributes 168. In some embodiments, attribute training data may be stored in database 128. In some embodiments, attribute training data may be received from one or more users, database 128, external computing devices, and/or previous iterations of processing. As a non-limiting example, attribute training data may include instructions from a user, who may be an expert user, a past user in embodiments disclosed herein, or the like, which may be stored in memory and/or stored in database 128, where the instructions may include labeling of training examples. In some embodiments, attribute training data may be updated iteratively on a feedback loop. As a non-limiting example, processor 104 may update attribute training data iteratively through a feedback loop as a function of entity data 112, outputs of machine learning models or classifiers described in this disclosure, or the like. In some embodiments, processor 104 may be configured to generate attribute classifier 122. In a non-limiting example, generating attribute classifier 122 may include training, retraining, or fine-tuning attribute classifier 122 using attribute training data or updated attribute training data. In some embodiments, processor 104 may be configured to determine attribute 168 using attribute classifier 122 (i.e. trained or updated attribute classifier 122). In some embodiments, entity or entity data 112 may be classified to an entity cohort using a cohort classifier. Cohort classifier may be consistent with any classifier discussed in this disclosure. Cohort classifier may be trained on cohort training data, wherein the cohort training data may include entity data 112 correlated to entity cohorts. In some embodiments, entity may be classified to entity cohort and processor 104 may determine attribute 168 based on the entity cohort using a machine-learning module as described in detail with respect to FIG. 3 and the resulting output may be used to update attribute training data. In some embodiments, generating training data and training machine-learning models may be simultaneous.

With continued reference to FIG. 1, in some embodiments, processor 104 may process entity data 112 using a language model. As used herein, a “language model” is a program capable of interpreting natural language, generating natural language, or both. In some embodiments, a language model may be configured to interpret the output of an automatic speech recognition function and/or an OCR function. A language model may include a neural network. A language model may be trained using a dataset that includes natural language. In non-limiting examples, such a dataset may be obtained from publicly available sources such as social media sites.

With continued reference to FIG. 1, generating language model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space May be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

With continued reference to FIG. 1, processor 104 may determine one or more language elements in entity data 112 by identifying and/or detecting associations between one or more language elements (including phonemes or phonological elements, morphemes or morphological elements, syntax or syntactic elements, semantics or semantic elements, and pragmatic elements) extracted from at least user data and/or response, including without limitation mathematical associations, between such words. Associations between language elements and relationships of such categories to other such term may include, without limitation, mathematical associations, including without limitation statistical correlations between any language element and any other language element and/or Language elements. Processor 104 may compare an input such as a sentence from entity data 112 with a list of keywords or a dictionary to identify language elements. For example, processor 104 may identify whitespace and punctuation in a sentence and extract elements comprising a string of letters, numbers or characters occurring adjacent to the whitespace and punctuation. Processor 104 may then compare each of these with a list of keywords or a dictionary. Based on the determined keywords or meanings associated with each of the strings, processor 104 may determine an association between one or more of the extracted strings and a feature of an organization operating apparatus 100, such as an association between a string containing the word “expertise” and a strength of an entity. Associations may take the form of statistical correlations and/or mathematical associations, which may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory.

With continued reference to FIG. 1, processor 104 may be configured to determine one or more language elements in entity data 112 using machine learning. For example, processor 104 may generate the language processing model by any suitable method, including without limitation a natural language processing classification algorithm; language processing model may include a natural language process classification model that enumerates and/or derives statistical relationships between input terms and output terms. An algorithm to generate language processing model may include a stochastic gradient descent algorithm, which may include a method that iteratively optimizes an objective function, such as an objective function representing a statistical estimation of relationships between terms, including relationships between input language elements and output patterns or conversational styles in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted word, phrase, and/or other semantic unit. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

With continued reference to FIG. 1, processor 104 may be configured to determine one or more language elements in entity data 112 using machine learning by first creating or receiving language classification training data. Training data may include data containing correlations that a machine-learning process may use to model relationships between two or more categories of data elements. For instance, and without limitation, training data may include a plurality of data entries, each entry representing a set of data elements that were recorded, received, and/or generated together; data elements may be correlated by shared existence in a given data entry, by proximity in a given data entry, or the like. Multiple data entries in training data may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data according to various correlations; correlations may indicate causative and/or predictive links between categories of data elements, which may be modeled as relationships such as mathematical relationships by machine-learning processes as described in further detail below. Training data may be formatted and/or organized by categories of data elements, for instance by associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements; for instance, and without limitation, training data may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 1, training data may include one or more elements that are not categorized; that is, training data may not be formatted or contain descriptors for some elements of data. Machine-learning algorithms and/or other processes may sort training data according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data to be made applicable for two or more distinct machine-learning algorithms as described in further detail below.

With continued reference to FIG. 1, language classification training data may be a training data set containing associations between language element inputs and associated language element outputs. Language element inputs and outputs may be categorized by communication form such as written language elements, spoken language elements, typed language elements, or language elements communicated in any suitable manner. Language elements may be categorized by component type, such as phonemes or phonological elements, morphemes or morphological elements, syntax or syntactic elements, semantics or semantic elements, and pragmatic elements. Associations may be made between similar communication types of language elements (e.g. associating one written language element with another written language element) or different language elements (e.g. associating a spoken language element with a written representation of the same language element). Associations may be identified between similar communication types of two different language elements, for example written input consisting of the syntactic element “that” may be associated with written phonemes /th/, /ă/, and /t/. Associations may be identified between different communication forms of different language elements. For example, the spoken form of the syntactic element “that” and the associated written phonemes above. Language classification training data may be created using a classifier such as a language classifier. An exemplary classifier may be created, instantiated, and/or run using processor 104, or another computing device. Language classification training data may create associations between any type of language element in any format and other type of language element in any format. Additionally, or alternatively, language classification training data may associate language element input data to a feature related to an operator of apparatus 100. For example, language classification training data may associate occurrences of the syntactic elements “expert,” “python,” and “programming,” in a single sentence with the feature of expertise in the programming language python.

With continued reference to FIG. 1, processor 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A)P(A)÷P(B), where P(A/B) is the probability of hypothesis A given data B also known as posterior probability; P(B/A) is the probability of data B given that the hypothesis A was true; P(A) is the probability of hypothesis A being truc regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, a language model may be used to process entity data for input into attribute classifier 122. In a non-limiting example, entity data may include descriptions of entity attributes using a variety of words, and a language model may be used to modify those descriptions such that they use consistent language. In a non-limiting example, entity data 112 may include manager-written descriptions of employees, which may use the words “expert,” “specialist,” and “talented” to indicate skill in a particular field; a language model may be used to identify these words as similar and replace them with a single word. Such a modified element of entity data 112 may be input into attribute classifier 122.

With continued reference to FIG. 1, in some embodiments, processor 104 may receive predetermined attribute list from a predetermined attribute list source. A predetermined attribute list source may include a computing device associated with entity, such as a computing device described as a potential entity data source above. In some embodiments, processor 104 may determine predetermined attribute list. A processor 104 may determine predetermined attribute list as a function of entity data 112. In a non-limiting example, entity data 112 may include a selection of attributes 168 that entity would like to have analyzed, and processor 104 may determine predetermined attribute list as a function of those attributes 168. In another non-limiting example, entity data 112 may include which industry entity is in, and processor 104 may determine predetermined attribute list as a function of that industry.

With continued reference to FIG. 1, in some embodiments, processor 104 may identify an attribute cluster by using a clustering algorithm. Clustering algorithm may be implemented, as a non-limiting example, using a k-means clustering algorithm. A “k-means clustering algorithm” as used in this disclosure, includes cluster analysis that partitions n attributes into k clusters in which each attribute belongs to the cluster with the nearest mean, using, for instance a training set described below. “Cluster analysis” as used in this disclosure, includes grouping a set of attributes 168 in way that attributes 168 in the same group or cluster are more similar to each other than to those in other groups or clusters. Cluster analysis may be performed by various cluster models that include connectivity models such as hierarchical clustering, centroid models such as k-means, distribution models such as multivariate normal distribution, density models such as density-based spatial clustering of applications with nose (DBSCAN) and ordering points to identify the clustering structure (OPTICS), subspace models such as biclustering, group models, graph-based models such as a clique, signed graph models, neural models, and the like. Cluster analysis may include hard clustering whereby each attribute 168 belongs to a cluster or not. Cluster analysis may include soft clustering or fuzzy clustering whereby each attribute 168 belongs to each cluster to a certain degree such as for example a likelihood of belonging to a cluster; for instance, and without limitation, a fuzzy clustering algorithm may be used to identify clustering of gene combinations with multiple disease states, and vice versa. Cluster analysis may include strict partitioning clustering whereby each attribute 168 belongs to exactly one cluster. Cluster analysis may include strict partitioning clustering with outliers whereby attributes 168 may belong to no cluster and may be considered outliers. Cluster analysis may include overlapping clustering whereby attributes 168 may belong to more than one cluster. Cluster analysis may include hierarchical clustering whereby attributes 168 that belong to a child cluster also belong to a parent cluster. In some embodiments, an attribute cluster may include an outlier cluster as described in U.S. patent application Ser. No. 18/141,296, filed on Apr. 28, 2023, and titled “SYSTEMS AND METHODS FOR DATA STRUCTURE GENERATION,” having an attorney docket number of 1452-022USU1, the entirety of which is hereby incorporated by reference.

With continued reference to FIG. 1, computing device may generate a k-means clustering algorithm receiving unclassified attributes 168 and outputs a definite number of classified Attribute clusters wherein the attribute clusters each contain one or more attributes 168. K-means algorithm may select a specific number of groups or clusters to output, identified by a variable “k.” Generating a k-means clustering algorithm includes assigning inputs containing unclassified data to a “k-group” or “k-cluster” based on feature similarity. Centroids of k-groups or k-clusters may be utilized to generate classified attribute cluster. K-means clustering algorithm may select and/or be provided “k” variable by calculating k-means clustering algorithm for a range of k values and comparing results. K-means clustering algorithm may compare results across different values of k as the mean distance between cluster attributes 168 and cluster centroid. K-means clustering algorithm may calculate mean distance to a centroid as a function of k value, and the location of where the rate of decrease starts to sharply shift, this may be utilized to select a k value. Centroids of k-groups or k-cluster include a collection of feature values which are utilized to classify attribute clusters containing attributes 168.

With continued reference to FIG. 1, generating a k-means clustering algorithm may include generating initial estimates for k centroids which may be randomly generated or randomly selected from unclassified data input. K centroids may be utilized to define one or more clusters. K-means clustering algorithm may assign unclassified data to one or more k-centroids based on the squared Euclidean distance by first performing a data assigned step of unclassified data. K-means clustering algorithm may assign unclassified data to its nearest centroid based on the collection of centroids ci of centroids in set C. Unclassified data may be assigned to a cluster based on argmi [symbol] dist(ci,x)², where argmin includes argument of the minimum, ci includes a collection of centroids in a set C, and dist includes standard Euclidean distance. K-means clustering module may then recompute centroids by taking mean of all cluster attributes 168 assigned to a centroid's cluster. This may be calculated based on ci=1/|Si|Σxi [symbol] Si^{xi}. K-means clustering algorithm may continue to repeat these calculations until a stopping criterion has been satisfied such as when cluster attributes 168 do not change clusters, the sum of the distances have been minimized, and/or some maximum number of iterations has been reached.

With continued reference to FIG. 1, k-means clustering algorithm may be configured to calculate a degree of similarity index value. A “degree of similarity index value” as used in this disclosure, includes a distance measurement indicating a measurement between each attribute cluster generated by k-means clustering algorithm and a selected attribute 168. Degree of similarity index value may indicate how close a particular attribute 168 is to being classified by k-means algorithm to a particular cluster. K-means clustering algorithm may evaluate the distances of the attribute 168 to the k-number of clusters output by k-means clustering algorithm. Short distances between a set of attributes 168 and a cluster may indicate a higher degree of similarity between the attribute 168 and a particular cluster. Longer distances between attribute 168 and a cluster may indicate a lower degree of similarity between attribute 168 and a particular cluster.

With continued reference to FIG. 1, k-means clustering algorithm may select a classified attribute 168 as a function of the degree of similarity index value. In an embodiment, k-means clustering algorithm may select an attribute cluster with the smallest degree of similarity index value indicating a high degree of similarity between attribute 168 and the attribute cluster. Alternatively, or additionally k-means clustering algorithm may select a plurality of clusters having low degree of similarity index values to attributes 168, indicative of greater degrees of similarity. Degree of similarity index values may be compared to a threshold number indicating a minimal degree of relatedness suitable for inclusion of attribute 168 in a cluster, where degree of similarity indices a-n falling under the threshold number may be included as indicative of high degrees of relatedness. The above-described illustration of feature learning using k-means clustering is included for illustrative purposes only and should not be construed as limiting potential implementation of clustering algorithms; persons skilled in the art, upon reviewing the entirety of this disclosure, will be aware of various additional or alternative clustering approaches that may be used consistently with this disclosure.

With continued reference to FIG. 1, in some embodiments, a k-means clustering algorithm may be trained on a dataset including a plurality of attributes that vary in one or more dimensions. In a non-limiting example, a set of attributes may include expertise in a variety of computer programs, and a variable may include the degree to which expertise in a computer program is correlated with the number of papers an individual with that expertise has written in a particular field; in this situation, a k-means clustering algorithm may be used to determine clusters among the training data, and attributes input into the algorithm may be assigned to these attribute clusters.

With continued reference to FIG. 1, in some embodiments, particle swarm optimization is used to determine Attribute clusters. In some embodiments, particle swarm optimization may involve a population of candidate solutions that are moved around in a search space as a function of the best-known position for that particle and the entire population's best-known position.

With continued reference to FIG. 1, processor 104 is configured to determine a component word set 172 as a function of a plurality of attributes 168. In some embodiments, processor 104 may determine a component word set 172 as a function of attribute cluster. In some embodiments, processor 104 may determine a component word set 172 as a function of attribute cluster using a component word set machine learning model 176. As used herein, a “component word set” is a set of words that has a desired level of relatedness with respect to an attribute or attribute cluster. In some embodiments, component word set machine learning model 176 may include an unsupervised machine learning model trained to recognize associations between words. In a non-limiting example, component word set machine learning model 176 may be trained on a dataset including samples of text and may be trained to recognize associations between words. In a non-limiting example, component word set machine learning model 176 may be trained to recognize associations between words as a function of how frequently words are used together. In some embodiments, component word set machine learning model 176 may accept as an input a plurality of words and may output association ratings between those words. In a non-limiting example, component word set machine learning model 176 may accept as an input two words and may output an association rating between those words. An association rating may be a number, such as a number between 0 and 1. In some embodiments, component word set machine learning model 176 may accept as an input one or more words and may output one or more words that are sufficiently associated with the input words; such a component word set machine learning model 176 may also output association ratings between the input and output words. In a non-limiting example, component word set machine learning model 176 may accept as an input a single word and may output a plurality of words, and association ratings between the input word and each of the output words.

With continued reference to FIG. 1, in some embodiments, processor 104 may generate component word set training data. In a non-limiting example, component word set training data may include correlations between exemplary entity data, exemplary distinct rates, exemplary functional models, exemplary attributes, exemplary component words and/or exemplary component word set. For example, and without limitation, component word set training data may include correlations between attributes 168 and component words or component word sets 172. For example, and without limitation, component word set training data may include correlations between entity data 112 and component words. In some embodiments, component word set training data may be stored in database 128. In some embodiments, component word set training data may be received from one or more users, database 128, external computing devices, and/or previous iterations of processing. As a non-limiting example, component word set training data may include instructions from a user, who may be an expert user, a past user in embodiments disclosed herein, or the like, which may be stored in memory and/or stored in database 128, where the instructions may include labeling of training examples. In some embodiments, component word set training data may be updated iteratively on a feedback loop. As a non-limiting example, processor 104 may update component word set training data iteratively through a feedback loop as a function of entity data 112, distinct routine 132, functional model 160, attribute 168, attribute cluster, component word, output of machine learning models or classifiers described in this disclosure, or the like. In some embodiments, processor 104 may be configured to generate component word set machine learning model 176. In a non-limiting example, generating component word set machine learning model 176 may include training, retraining, or fine-tuning component word set machine learning model 176 using component word set training data or updated component word set training data. In some embodiments, processor 104 may be configured to determine component word or component word set using component word set machine learning model 176 (i.e. trained or updated component word set machine learning model). In some embodiments, entity or entity data 112 may be classified to an entity cohort using a cohort classifier. Cohort classifier may be consistent with any classifier discussed in this disclosure. Cohort classifier may be trained on cohort training data, wherein the cohort training data may include entity data 112 correlated to entity cohorts. In some embodiments, entity may be classified to entity cohort and processor 104 may determine component word based on the entity cohort using a machine-learning module as described in detail with respect to FIG. 3 and the resulting output may be used to update component word set training data. In some embodiments, attributes 168 may be classified to attribute cluster using attribute classifier 122 as described in this disclosure. In some embodiments, attributes 168 may be classified to attribute cluster and processor 104 may determine component word based on the attribute cluster using a machine-learning module and the resulting output may be used to update component word set training data. In some embodiments, generating training data and training machine-learning models may be simultaneous.

With continued reference to FIG. 1, in some embodiments, processor 104 may input attribute 168 and/or attribute cluster or a word associated with attribute 168 and/or attribute cluster into component word set machine learning model 176. In some embodiments, a word input into component word set machine learning model 176 may be a word associated with multiple attributes 168 in an attribute cluster. In a non-limiting example, attribute cluster may include attributes 168 on expertise with several programming languages; in such a situation, a word associated with all of those programming languages may be input into component word set machine learning model 176. In some embodiments, attribute 168 and/or attribute cluster may be associated with a title and/or description. In some embodiments, a word input into component word set machine learning model 176 may be a word included in a description or title of attribute 168 and/or attribute cluster. In a non-limiting example, attribute cluster may have the title “expertise in python” and the word “python” may be input into component word set machine learning model 176. In some embodiments, a word associated with attribute 168 and/or attribute cluster and input into component word set machine learning model 176 may be a word from predetermined attribute list. In some embodiments, a word associated with attribute 168 and/or attribute cluster and input into component word set machine learning model 176 is a word manually selected and/or input by a human as a word associated with attribute 168 and/or attribute cluster.

With continued reference to FIG. 1, in some embodiments, processor 104 may determine whether a word is to be included in component word set 172 as a function of an association rating. In. some embodiments, an association rating may be compared to a threshold. In a non-limiting example, processor 104 may determine to include a word in component word set 172 if an association rating between it and a word input into component word set machine learning model 176 indicates a sufficiently strong association. In another non-limiting example, processor 104 may determine to include a word in component word set 172 if an association rating between it and a word associated with attribute cluster indicates a sufficiently strong association. In another non-limiting example, processor 104 may determine to include a word in component word set 172 if an association rating between it and a word associated with attribute cluster indicates a sufficiently weak association. In another non-limiting example, processor 104 may determine to include a word in component word set 172 if an association rating between it and a word associated with attribute cluster indicates an association strength between a maximum and a minimum.

With continued reference to FIG. 1, in some embodiments, component word set machine learning model 176 may input a first word from a predetermined word set and a second word associated with attribute 168 and/or attribute cluster and may output a component word and/or component word set 172. In some embodiments, apparatus 100 may receive predetermined word set from a predetermined word set source. A predetermined word set source may include a computing device associated with entity, such as a computing device described as a potential entity data source and/or predetermined attribute list source above. In some embodiments, processor 104 may determine predetermined word set. In non-limiting examples, processor 104 may determine predetermined word set as a function of entity data 112. In a non-limiting example, entity data 112 may include a selection of words entity would like to have analyzed, and processor 104 may determine predetermined word set as a function of those words.

With continued reference to FIG. 1, processor 104 is configured to generate distinct name 164 as a function of component word. In some embodiments, processor 104 may determine candidate name set or candidate name as a function of component word set 172 and determine distinct name 164 from candidate name set. In some embodiments, processor 104 may be configured to determine a candidate name set as a function of component word set 172. As used herein, a “candidate name” is a combination of at least two component words. In some embodiments, candidate name may include a combination of words in component word set 172. In some embodiments, candidate name may include a portmanteau of words in component word set 172. In some embodiments, candidate name may include a series of words in component word set 172. In a non-limiting example, if the words “international” and “learning” are in component word set 172, then candidate name may include “interlearn,” “international learn,” or “learning international.”

With continued reference to FIG. 1, in some embodiments, processor 104 may determine at least a candidate name as a function of component word set 172 using a component word combination machine learning model. In some embodiments, a component word combination machine learning model may accept as inputs a plurality of component words and may output a candidate name. In some embodiments, component word combination machine learning model may be trained using reinforcement learning. In some embodiments, component word combination machine learning model may be trained to maximize or minimize a score assigned to outputs of component word combination machine learning model. In some embodiments, outputs of component word combination machine learning model may be assigned a score based on how well the output conforms to language rules, patterns, and the like. In a non-limiting example, if a component word combination machine learning model output is in English and uses too many consonants in a row, then that output may be assigned an unfavorable score. In another non-limiting example, if a component word combination machine learning model output is in English and the subject of a descriptor and the descriptor are in the wrong order, then that output may be assigned an unfavorable score; in a non-limiting example, if input words are “green” and “skyscraper,” then the output “green skyscraper” may be given a better score than “skyscraper green.”

With continued reference to FIG. 1, in some embodiments, component word combination machine learning model may be trained using supervised learning. In some embodiments, component word combination machine learning model may be trained on a data set including words associated with combinations of those words. In a non-limiting example, component word combination machine learning model may be trained on a data set including an element of data including component words “side” and “walk,” associated with words formed from combinations of those words such as “sidewalk.”

With continued reference to FIG. 1, in some embodiments, component word combination machine learning model may output one or more combination words, and measures of quality associated with those combination words. In some embodiments, processor 104 may determine words output from component word combination machine learning model to be candidate names based on a comparison between a threshold and a measure of quality output by component word combination machine learning model. In non-limiting examples, processor 104 may determine words output from component word combination machine learning model to be candidate names based on whether an associated measure of quality is greater than a threshold, less than a threshold, or between a maximum and a minimum.

With continued reference to FIG. 1, in some embodiments, component word combination machine learning model may accept as inputs 2 words, 3 words, 4 words, or more. In some embodiments, the full component word set 172 is input into component word combination machine learning model. In some embodiments, a subset of component word set 172 may be inputted to component word combination machine learning model.

With continued reference to FIG. 1, in some embodiments, processor 104 may generate component word combination training data. In a non-limiting example, component word combination training data may include correlations between exemplary entity data, exemplary distinct rates, exemplary functional models, exemplary component words, exemplary component word set, exemplary candidate names and/or exemplary candidate name sets. For example, and without limitation, component word combination training data may include correlations between component words and candidate names. In some embodiments, component word combination training data may be stored in database 128. In some embodiments, component word combination training data may be received from one or more users, database 128, external computing devices, and/or previous iterations of processing. As a non-limiting example, component word combination training data may include instructions from a user, who may be an expert user, a past user in embodiments disclosed herein, or the like, which may be stored in memory and/or stored in database 128, where the instructions may include labeling of training examples. In some embodiments, component word combination training data may be updated iteratively on a feedback loop. As a non-limiting example, processor 104 may update component word combination training data iteratively through a feedback loop as a function of entity data 112, distinct routine 132, functional model 160, attribute 168, attribute cluster, component word, component word set, candidate name, candidate name set, outputs of component word set machine learning model 176, outputs of machine learning models or classifiers described in this disclosure, or the like. In some embodiments, processor 104 may be configured to generate component word combination machine learning model. In a non-limiting example, generating component word combination machine learning model may include training, retraining, or fine-tuning component word combination machine learning model using component word combination training data or updated component word combination training data. In some embodiments, processor 104 may be configured to determine candidate name and/or candidate name set using component word combination machine learning model (i.e. trained or updated component word combination machine learning model). In some embodiments, entity may be classified to entity cohort and processor 104 may determine candidate name based on the entity cohort using a machine-learning module as described in detail with respect to FIG. 3 and the resulting output may be used to update component word combination training data. In some embodiments, generating training data and training machine-learning models may be simultaneous.

With continued reference to FIG. 1, in some embodiments, processor 104 may be configured to determine candidate name and/or candidate name set. Using similar factors to those described above in the context of training a machine learning model using reinforcement learning, processor 104 may determine candidate name and/or candidate name set based on language rules, patterns, and the like. In a non-limiting example, processor 104 may generate multiple combination words, and may assess them based on factors such as whether they use descriptors in the correct order in relation to the descriptor's subject, whether prefixes and suffixes are in the correct location, whether impermissible letter combinations are used, and the like; in such an example, processor 104 may determine a word to be candidate name if its assessment is better than a threshold, and/or is better than other assessed words.

With continued reference to FIG. 1, in some embodiments, processor 104 may determine candidate name as a function of a previously identified candidate name or component word. In some embodiments, processor may determine candidate name as a function of a synonym of a previously identified candidate name or component word. In some embodiments, processor 104 may determine a synonym using a language processing model. In an embodiment, processor 104 may determine candidate name as a function of a previously identified candidate name if intelligibility rating and/or appeal rating indicate low intelligibility and/or appeal. In a non-limiting example, processor 104 may generate a first candidate name, then processor 104 may analyze the first candidate name using intelligibility rating machine learning model, receiving a low intelligibility rating from intelligibility rating machine learning model, then processor 104 may identify one or more synonyms of a component word used to determine the first candidate name, then processor 104 may determine a second candidate name including the component word.

With continued reference to FIG. 1, in some embodiments, processor 104 may generate candidate name by performing the following steps in a loop: 1. Identify a candidate name; 2. Determine whether the candidate name is suitable by analyzing its intelligibility and appeal as described herein; 3.1. If it is suitable, identify it as distinct name and end the loop; 3.2. If it is not suitable, identify a synonym of a component word used to determine the candidate name; 3.3. If it is not suitable, and there is no synonym of a component word used to determine the candidate name, then end the loop and determine a candidate name from component words determined from an attribute cluster, as described herein; 4. Determine a new candidate name, using the synonym as a component word, and restart the loop.

With continued reference to FIG. 1, in some embodiments, processor 104 may be configured to determine distinct name 164 using a name identification machine learning model 180. In some embodiments, name identification machine learning model 180 may include an intelligibility rating machine learning model. In some embodiments, name identification machine learning model 180 may include an appeal rating machine learning model.

With continued reference to FIG. 1, in some embodiments, processor 104 may generate distinct name 164 by using intelligibility rating machine learning model to generate an intelligibility rating and determining a distinct name 164 as a function of intelligibility rating. In some embodiments, intelligibility rating machine learning model may accept as an input a word and may output intelligibility rating.

With continued reference to FIG. 1, in some embodiments, intelligibility rating machine learning model may be trained using supervised learning. In some embodiments, intelligibility rating machine learning model may be trained on a dataset including letter combinations associated with a measure of how intelligible the letter combination is. In a non-limiting example, a measure of how intelligible a letter combination is may be determined as a function of whether the letter combination forms a word in a dictionary, to what degree the letter combination forms a commonly used name, to what degree the letter combination follows language rules, to what degree the letter combination follows common language patterns, and/or to what degree a human rates the letter combination as being intelligible.

With continued reference to FIG. 1, in some embodiments, intelligibility rating machine learning model may be trained using reinforcement learning. In some embodiments, intelligibility rating machine learning model may be trained to maximize or minimize a score assigned to outputs of intelligibility rating machine learning model. In some embodiments, intelligibility rating machine learning model may be assigned a score based on a measure of how intelligible the output is. As with the description of training intelligibility rating machine learning model using supervised learning, a measure of how intelligible an output is may be determined as a function of whether the output is a word in a dictionary, to what degree the output is a commonly used name, to what degree the output follows language rules, to what degree the output follows common language patterns, and/or to what degree a human rates the output as being intelligible.

With continued reference to FIG. 1, in some embodiments, processor 104 may generate intelligibility rating training data. In a non-limiting example, intelligibility rating training data may include correlations between exemplary entity data, exemplary distinct rates, exemplary functional models, exemplary candidate names, exemplary candidate name sets, exemplary intelligibility ratings and/or exemplary distinct names. For example, and without limitation, intelligibility rating training data may include correlations between candidate names and intelligibility rating or distinct name 164 that includes high intelligibility rating (e.g., higher than a threshold). In some embodiments, intelligibility rating training data may be stored in database 128. In some embodiments, intelligibility rating training data may be received from one or more users, database 128, external computing devices, and/or previous iterations of processing. As a non-limiting example, intelligibility rating training data may include instructions from a user, who may be an expert user, a past user in embodiments disclosed herein, or the like, which may be stored in memory and/or stored in database 128, where the instructions may include labeling of training examples. In some embodiments, intelligibility rating training data may be updated iteratively on a feedback loop. As a non-limiting example, processor 104 may update intelligibility rating training data iteratively through a feedback loop as a function of entity data 112, distinct routine 132, functional model 160, attribute 168, attribute cluster, component word, component word set, candidate name, candidate name set, intelligibility rating, distinct name 164, threshold, outputs of component word set machine learning model 176, component word combination machine learning model, or the like, outputs of machine learning models or classifiers described in this disclosure, or the like. In some embodiments, processor 104 may be configured to generate intelligibility rating machine learning model. In a non-limiting example, generating intelligibility rating machine learning model may include training, retraining, or fine-tuning intelligibility rating machine learning model using intelligibility rating training data or updated intelligibility rating training data. In some embodiments, processor 104 may be configured to determine intelligibility rating or distinct name 164 with high intelligibility rating using intelligibility rating machine learning model (i.e. trained or updated intelligibility rating machine learning model). In some embodiments, entity may be classified to entity cohort and processor 104 may determine intelligibility rating or distinct name 164 with high intelligibility rating based on the entity cohort using a machine-learning module as described in detail with respect to FIG. 3 and the resulting output may be used to update intelligibility rating training data. In some embodiments, generating training data and training machine-learning models may be simultaneous.

With continued reference to FIG. 1, in some embodiments, apparatus 100 may identify a distinct name 164 by using appeal rating machine learning model to generate an appeal rating and determining a distinct name 164 as a function of appeal rating. In some embodiments, appeal rating machine learning model may accept as an input a word and may output appeal rating.

With continued reference to FIG. 1, in some embodiments, appeal rating machine learning model may be trained using supervised learning. In some embodiments, appeal rating machine learning model may be trained on a dataset including letter combinations associated with a measure of how appealing the letter combination is. In a non-limiting example, a measure of how appealing a letter combination is may be determined as a function of ratings by humans of how appealing certain words, phrases, concepts, and the like arc.

With continued reference to FIG. 1, in some embodiments, appeal rating machine learning model may be trained using reinforcement learning. In some embodiments, appeal rating machine learning model may be trained to maximize or minimize a score assigned to appeal rating machine learning model outputs. In some embodiments, appeal rating machine learning model may be assigned a score based on a measure of how appealing the output is, which may be determined, in a non-limiting example, by using human ratings of how appealing certain words, phrases, concepts, and the like arc.

With continued reference to FIG. 1, in some embodiments, processor 104 may generate appeal rating training data. In a non-limiting example, appeal rating training data may include correlations between exemplary entity data, exemplary distinct rates, exemplary functional models, exemplary candidate names, exemplary candidate name sets, exemplary appeal ratings and/or exemplary distinct names. For example, and without limitation, appeal rating training data may include correlations between candidate names and appeal rating or distinct name 164 that includes high appeal rating (e.g., higher than a threshold). In some embodiments, appeal rating training data may be stored in database 128. In some embodiments, appeal rating training data may be received from one or more users, database 128, external computing devices, and/or previous iterations of processing. As a non-limiting example, appeal rating training data may include instructions from a user, who may be an expert user, a past user in embodiments disclosed herein, or the like, which may be stored in memory and/or stored in database 128, where the instructions may include labeling of training examples. In some embodiments, appeal rating training data may be updated iteratively on a feedback loop. As a non-limiting example, processor 104 may update appeal rating training data iteratively through a feedback loop as a function of entity data 112, distinct routine 132, functional model 160, attribute 168, attribute cluster, component word, component word set, candidate name, candidate name set, appeal rating, distinct name 164, threshold, outputs of component word set machine learning model 176, component word combination machine learning model, or the like, outputs of machine learning models or classifiers described in this disclosure, or the like. In some embodiments, processor 104 may be configured to generate appeal rating machine learning model. In a non-limiting example, generating appeal rating machine learning model may include training, retraining, or fine-tuning appeal rating machine learning model using appeal rating training data or updated appeal rating training data. In some embodiments, processor 104 may be configured to determine appeal rating or distinct name 164 with high appeal rating using appeal rating machine learning model (i.e. trained or updated appeal rating machine learning model). In some embodiments, entity may be classified to entity cohort and processor 104 may determine appeal rating or distinct name 164 with high appeal rating based on the entity cohort using a machine-learning module as described in detail with respect to FIG. 3 and the resulting output may be used to update appeal rating training data. In some embodiments, generating training data and training machine-learning models may be simultaneous.

With continued reference to FIG. 1, in some embodiments, processor 104 may determine a distinct name 164 as a function of intelligibility rating and/or appeal rating. In some embodiments, intelligibility rating and/or appeal rating may be compared to a threshold. In non-limiting examples, processor 104 may determine a distinct name 164 based on whether intelligibility rating and/or appeal rating are greater than a threshold, less than a threshold, or between a maximum and a minimum. In some embodiments, intelligibility rating and appeal rating may be compared to thresholds individually, in combination, or both. In a non-limiting example, processor 104 may be configured to determine candidate name to be a distinct name 164 if intelligibility rating is above a first threshold, and appeal rating is above a second threshold. In another non-limiting example, processor 104 may be configured to determine candidate name based on a function of both intelligibility rating and appeal rating, such as a weighted sum of intelligibility rating and appeal rating. In some embodiments, processor 104 may determine a distinct name 164 based on a comparison between the intelligibility ratings, appeal ratings, and/or a function of both for the candidate names in candidate name set. In a non-limiting example, processor 104 may calculate a weighted sum of intelligibility rating and appeal rating for candidate names in candidate name set, and may select a distinct name 164 based on which candidate name has the greatest weighted sum. As described below, user interface data structure 164 and visual elements may also be determined as a function of intelligibility rating, appeal rating, and/or a function of both. Additional disclosure related to distinct name 164 or method of determining distinct name 164 can be found in U.S. patent application Ser. No. 18/141,441, filed on Apr. 30, 2023, entitled “SYSTEMS AND METHODS FOR IDENTIFYING A NAME,” having an attorney docket number of 1452-020USU1, the entirety of which is incorporated herein as a reference.

With continued reference to FIG. 1, a datum described herein may be represented as a data structure. In some embodiments, a data structure may include one or more functions and/or variables, as a class might in object-oriented programming. In some embodiments, a data structure may include data in the form of a Boolean, integer, float, string, date, and the like. In a non-limiting example, a component word data structure may include a string. In some embodiments, data in a data structure may be organized in a linked list, tree, array, matrix, tenser, and the like. In a non-limiting example, component word set 172 may include a list of strings, with each string representing a component word. In some embodiments, a data structure may include or be associated with one or more elements of metadata. A data structure may include one or more self-referencing data elements, which processor 104 may use in interpreting the data structure. In a non-limiting example, a data structure may include “<string>” and “</string>,” tags, indicating that the content between the tags is a string.

With continued reference to FIG. 1, a data structure may be stored in, for example, memory 108 or a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, a data structure may be read and/or manipulated by processor 104. In a non-limiting example, attribute 168 data structures may include strings describing those attributes, and these strings may be read by processor 104 and input into component word set machine learning model 176. In another non-limiting example, component word set machine learning model 176 may output a component word; processor 104 may then create component word set 172 and add component word to it, or may add component word to an existing component word set 172. In another non-limiting example, a candidate name data structure may include a string representing the text of the candidate name, an integer representing an intelligibility rating, and an integer representing an appeal rating, and processor 104 may modify the integer representing the intelligibility rating upon receiving an output from intelligibility rating machine learning model.

With continued reference to FIG. 1, in some embodiments, a data structure may be calibrated. In some embodiments, a machine learning model described herein may be represented by a data structure, and that data structure may be trained using a machine learning algorithm. In a non-limiting example, a data structure may include an array of data representing the biases of connections of a neural network. In this example, the neural network may be trained on a set of training data, and a back propagation algorithm may be used to modify the data in the array.

With continued reference to FIG. 1, processor 104 may be configured to generate a user interface data structure 184 comprising the at least one distinct routine 132 and the functional model 160, wherein user interface data structure is configured to be displayed. As used in this disclosure, “user interface data structure” is a data structure representing a specialized formatting of data on a computer configured such that the information can be organized, processed, stored, and retrieved quickly and effectively for a user interface. Additionally, or alternatively, user interface data structure 184 may further include each frequency datum, each of the plurality of routine categories, and the like. In such an embodiment, user interface data structure 184 may allow the at least one distinct routine 132 and the functional model 160 to be displayed on a display, graphical user interface, and the like. The at least one distinct routine 132 and the functional model 160 may be reviewed by a user, entity executive, and any other decision makers for entity to gather information quickly and efficiently about the at least one distinct routine 132 and/or the functional model 160. Additionally, layered structure for at least one distinct routine 132 and the functional model 160 may provide additional information about distinct routines that are central to the entity and data associated with these distinct routines.

Continuing to refer to FIG. 1, processor 104 is communicatively connected to a graphical user interface (GUI) 188 configured to display any information from apparatus 100 and/or any computing device. For the purposes of this disclosure, a “user interface” is a means by which a user and a computer system interact; for example, through the use of input devices and software. A user interface may include graphical user interface, command line interface (CLI), menu-driven user interface, touch user interface, voice user interface (VUI), form-based user interface, any combination thereof and the like. In some embodiments, a user may interact with the user interface using a computing device 112 distinct from and communicatively connected to at least a processor. For example, a smart phone, smart, tablet, or laptop operated by the user and/or participant. A user interface may include one or more graphical locator and/or cursor facilities allowing a user to interact with graphical models and/or combinations thereof, for instance using a touchscreen, touchpad, mouse, keyboard, and/or other manual data entry device. A “graphical user interface,” as used herein, is a graphical form of user interface that allows users to interact with electronic devices. GUI 188 may be configured to be displayed on, without limitation, a display; the display may include any display as described in the entirety of this disclosure such as a light emitting diode (LED) screen, liquid crystal display (LCD), organic LED, cathode ray tube (CRT), touch screen, or any combination thereof.

With further reference to FIG. 1, GUI 188 may be configured to receive user interface data structure 184 for any combination of at least one distinct routine 132, the functional model 160, each frequency datum, each of the plurality of routine categories, and the like. Additionally, or alternatively, GUI 188 may be configured to display at least one distinct routine 132, the functional model 160, each frequency datum, each of the plurality of routine categories on a respective portion of GUI 188 for review by a user, entity executive, and any other decision makers for entity to gather information about distinct routines central to the entity. For example, at least one distinct routine 132 may be displayed on a first portion of GUI 188 and functional model 160 may be displayed on a second portion of GUI 188.

With continued reference to FIG. 1, in some embodiments, processor 104 may determine a user interface data structure 184 as a function of distinct name 164. In some embodiments, a user interface data structure 184 may include a visual element. In some embodiments, a user interface data structure 184 may include a rule for displaying visual element (e.g., user interface data structure rule). In some embodiments, a user interface data structure 184 may be determined as a function of distinct name 164. In some embodiments, a user interface data structure 184 may be determined as a function of an item from the list consisting of predetermined attribute list, entity data 112, attribute 168, attribute cluster, component word, component word set 172, candidate name, candidate name set, intelligibility rating, appeal rating, and distinct name 164. In a non-limiting example, a user interface data structure 184 may be generated such that visual element describing or highlighting distinct name 164 is displayed to a user or entity. In another non-limiting example, a user interface data structure 184 may be generated such that component word and/or component word set 172 is compared to component words associated with another entity. In a non-limiting example, a user interface data structure 184 may be generated such that component word is compared to a selected word. In a non-limiting example, a user interface data structure 184 may be generated such that attribute cluster, component word set 172, and a selected word are presented to a user. Visual element may include, for example, one or more elements of text, images, shapes, charts, particle effects, interactable features, and the like. In a non-limiting example, visual element may include a description of an entity in text, and distinct name 164 in text. In a non-limiting example, visual element may include text describing an attribute cluster, distinct name 164 in text, and a particle effect around the text of distinct name 164. In a non-limiting example, visual element may include images depicting a plurality of entities, and text describing component words associated with those entities.

With continued reference to FIG. 1, in some embodiments, a user interface data structure 184 may include rules governing if or when visual element is displayed. In a non-limiting example, a user interface data structure 184 may include a rule causing a visual element describing candidate name to be displayed when a user selects candidate name using a GUI. In some embodiments, a user interface data structure 184 may include rules for presenting more than one visual element, or more than one visual element at a time. In an embodiment, about 1, 2, 3, 4, 5, 10, 20, or 50 visual elements are displayed simultaneously.

With continued reference to FIG. 1, in some embodiments, a user interface data structure rule may apply to a single visual element or datum, or to more than one visual element or datum. In some embodiments, a user interface data structure 184 may categorize data into one or more categories and may apply a rule to all data in a category, to all data in an intersection of categories, or all data in a subsection of a category (such as all data in a first category and not in a second category). In a non-limiting example, a user interface data structure 184 may categorize attributes 168 according to whether they are members of a particular attribute cluster or not. A user interface data structure 184 may rank data or assign numerical values to them. In a non-limiting example, a user interface data structure 184 may rank candidate names by their intelligibility ratings. A numerical value may, for example, measure the degree to which a first datum is associated with a category or with a second datum. In a non-limiting example, a numerical value may measure the degree to which attribute 168 is associated with a particular attribute cluster. A user interface data structure 184 may apply rules based on a comparison between a ranking or numerical value and a threshold. In a non-limiting example, a user interface data structure 184 may apply a highlighting effect to all attributes 168 associated with a particular attribute cluster. Rankings, numerical values, categories, and the like may be used to set user interface data structure rules. Similarly, rankings, numerical values, categories, and the like may be applied to visual elements, and visual elements may be applied based on them. In a non-limiting example, user or entity may select attribute cluster, and visual element highlighting all attributes 168 associated with attribute cluster may be displayed.

With continued reference to FIG. 1, in some embodiments, visual element may be interacted with. For example, visual element may include an interface, such as a button or menu. In some embodiments, visual element may be interacted with using a user device such as a smartphone.

With continued reference to FIG. 1, in some embodiments, processor 104 may determine visual element. In some embodiments, processor 104 may display visual element to user or entity. In some embodiments, processor 104 may transmit visual element to a display. A display may communicate visual element to user or entity. A display may include, for example, a smartphone screen, a computer screen, or a tablet screen. A display may be configured to provide a visual interface. A visual interface may include one or more virtual interactive elements such as, without limitation, buttons, menus, and the like. A display may include one or more physical interactive elements, such as buttons, a computer mouse, or a touchscreen, which allow user or entity to input data into the display. Interactive elements may be configured to enable interaction between a user and a computing device. In some embodiments, a user interface data structure 184 is determined as a function of data input by user or entity into a display.

Continuing to reference FIG. 1, GUI 188 may be configured to receive a user input. In an embodiment, GUI 188 may be configured to receive a user input that selects (e.g., click on, interacts with, and the like) any portion of GUI 188. For example, portions of the GUI 188 may be a first portion displaying the at least one distinct routine 132, a second portion displaying the functional model 160, as described above, and any portion of GUI 188 may be selected by the user. Additionally, GUI 188 may be configured to display a subsequent distinct routine 132 as a function of user input. For example, GUI 188 may be configured to receive a user input selecting a first portion of GUI 188, where the at least one distinct routine 132 may be displayed, and GUI 188 may be configured to display for example, a second distinct routine 132 of the at least one distinct routine 132.

Now referencing FIG. 2, an exemplary embodiment 200 of GUI 188 is shown. As used in the current disclosure, a “graphical user interface” is a graphical form of user interface that allows users to interact with electronic devices. GUI 188 may be displayed on a display device. Display device may include, but is not limited to, a smartphone, tablet, laptop, monitor, tablet, and the like. Display device may include a separate device that includes a transparent screen configured to display computer generated images and/or information. The user may view the information displayed on the display device in real time. In the exemplary embodiment 200, GUI 188 may include a first portion 204 and a second portion 208 but is not limited to such an embodiment. First portion 204 may be configured to display at least one distinct routine. Second portion 208 may be configured to display a functional model. The at least one distinct routine may be consistent with any distinct routine as discussed herein. Functional model may be consistent with any functional model as discussed herein. In the exemplary embodiment 200, GUI 188 may include distinct name 164 displayed on the display device in real time. As a non-limiting example, GUI 188 may include distinct name 164 for entity, functional model, distinct routine, or the like.

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm instantiated in hardware or software logic, data structures, and/or functions that will be performed by a computing device/module to produce outputs 308 given data provided as inputs 312; this is in contrast to a non-machine learning software program where the commands to be executed are determined in advance by a user and written in a programming language.

Still referring to FIG. 3, “training data,” as used herein, is data containing correlations that a machine-learning process may use to model relationships between two or more categories of data elements. For instance, and without limitation, training data 304 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data 304 used by machine-learning module 300 may correlate any input data as described in this disclosure to any output data as described in this disclosure. As a non-limiting illustrative example, inputs may include entity data 112, distinct routine 132, institutional routine 156, functional model 160, distinct name 164, attribute 168, component word set 172, component word, candidate name set, candidate name, or any inputs described in this disclosure. As another non-limiting illustrative example, outputs may include distinct routine 132, institutional routine 156, functional model 160, distinct name 164, attribute 168, component word set 172, component word, candidate name set, candidate name, or any outputs described in this disclosure.

Further referring to FIG. 3, training data may be filtered, sorted, and/or selected using one or more supervised and/or unsupervised machine-learning processes and/or models as described in further detail below; such models may include without limitation a training data classifier 316. Training data classifier 316 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 300 may generate a classifier using a classification algorithm, defined as a processes whereby a computing device and/or any module and/or component operating thereon derives a classifier from training data 304. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 316 may classify elements of training data to a cohort of entity. For example, and without limitation, training data classifier 316 may classify elements of training data as a function of age, size, industry type, project type, or the like.

Still referring to FIG. 3, computing device 304 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A)P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 304 may then calculate a likelihood table by calculating probabilities of different data entries and classification labels. Computing device 304 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 3, computing device 304 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 3, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 3, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input. value collocated in a data record with the retrieved value, provided by a user and/or other device, or the like.

Continuing to refer to FIG. 3, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 3, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 3, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 3, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural. network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 3, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 3, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 3, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Further referring to FIG. 3, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 3, machine-learning processes as described in this disclosure may be used to generate machine-learning models 324. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 324 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, machine-learning algorithms may include at least a supervised machine-learning process 328. At least a supervised machine-learning process 328, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include entity data 112, distinct routine 132, institutional routine 156, functional model 160, distinct name 164, attribute 168, component word set 172, component word, candidate name set, candidate name, or any inputs described in this disclosure and distinct routine 132, institutional routine 156, functional model 160, distinct name 164, attribute 168, component word set 172, component word, candidate name set, candidate name, or any outputs described in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

With further reference to FIG. 3, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 3, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 332 may not require a response variable; unsupervised processes 332 may be used to find interesting patterns and/or inferences between variables, to determine a degree of correlation between two or more variables, or the like.

Still referring to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 3, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 3, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 3, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 3, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 3, one or more processes or algorithms described above may be performed by at least a dedicated hardware unit 336. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 336 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 336 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 336 to perform one or more operations described herein, such as evaluation of model and/or algorithm outputs, one-time or iterative updates to parameters, coefficients, weights, and/or biases, and/or any other operations such as vector and/or matrix operations as described in this disclosure.

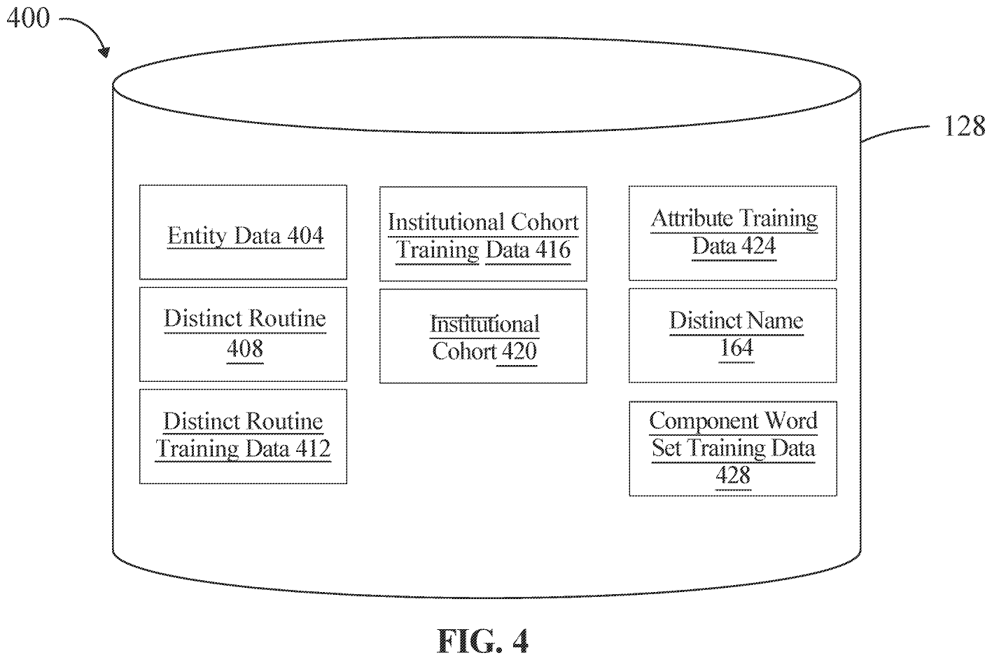

Now referencing FIG. 4, an exemplary embodiment 400 of database 128 is shown. Database 128 may be implemented, without limitation, as a relational database, a key-value retrieval database such as a NOSQL database, or any other format or structure for use as a database that a person skilled in the art would recognize as suitable upon review of the entirety of this disclosure. A key-value retrieval database may include any key such as voice activation. Database 128 may alternatively or additionally be implemented using a distributed data storage protocol and/or data structure, such as a distributed hash table or the like. Database 128 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. Database 128 may be used to store entity data 404, at least one distinct routine 408, distinct routine training data 412, institutional cohort training data 416, institutional cohort 420, attribute training data 424, distinct name 164, component word set training data 428, and the like. Entity data 404 may be consistent with any entity data 112 as discussed above. At least one distinct routine 408 may be consistent with any at least one distinct routine 132 as discussed herein. Distinct routine training data 412 and cohort training data 416 may be consistent with any training data as discussed herein. Institutional cohort 420 may be consistent with any institutional cohort as discussed herein. Database 128 may be used to store attribute 168, component word set 172, component word, candidate name set, candidate name, functional model 160, institutional routine 156, institutional cohort 144, intelligibility rating training data, appeal rating training data, component word combination training data, or the like.

Referring now to FIG. 5, an exemplary embodiment of method 500 for intelligently determining and implementing distinct routines for entities is shown. Step 505 of method 500 includes receiving, by at least a processor, entity data associated with an entity. In an embodiment, the entity data may comprise network interaction data with at least one external user device. Additionally, or alternatively, entity data may comprise user-input data from at least one entity user associated with the entity. These may be implemented, without limitation, as described above in reference to FIGS. 1-4.

With continued reference to FIG. 5, step 510 of method 500 includes generating, by the at least a processor, at least one distinct routine for the entity as a function of the entity data. In an embodiment, the generating the at least one distinct routine may comprise identifying, by the at least a processor, at least one institutional cohort to the entity, detecting, by the at least a processor, at least one institutional routine of the institutional cohort, and determining, by the at least a processor, the at least one distinct routine as a function of the at least one institutional routine. Additionally, or alternatively, determining the at least one distinct routine as a function of the at least one institutional routine may comprise calculating, by the at least a processor, a distance metric between each distinct routine and each institutional routine and determining, by the at least a processor, the at least one distinct routine as a function of the distance metric between each distinct routine and each institutional routine. This may be implemented, without limitation, as described above in reference to FIGS. 1-4.

With further reference to FIG. 5, step 515 of method 500 includes generating, by the at least a processor, a functional model as a function of the at least one distinct routine. In an embodiment, generating the functional model as a function of the at least one distinct routine may comprise combining, by the at least a processor, each distinct routine of the at least one distinct routine. Additionally, or alternatively, generating the functional model as a function of the at least one distinct routine further may comprise classifying, by the at least a processor, each of the at least one distinct routine into a plurality of routine categories as a function of a routine classifier, selecting, by the at least a processor, one distinct routine from each of the plurality of routine categories, and combining, by the at least a processor, each of the selected distinct routines as the functional model. In an embodiment, selecting the at least one distinct routine from each of the plurality of routine categories may comprise determining, by the at least a processor, a frequency datum for each of the at least one distinct routine in the entity data, comparing, by the at least a processor, the frequency datum for each of the at least one distinct routine, and selecting, by the at least a processor, the at least one distinct routine as a function of the comparing of the frequency datum. These may be implemented, without limitation, as described above in reference to FIGS. 1-4.

Continuing to reference FIG. 5, step 520 of method 500 includes generating, by the at least a processor, a user interface data structure comprising the at least one distinct routine and the functional model, wherein the user interface data structure is configured to be displayed. This may be implemented, without limitation, as described above in reference to FIGS. 1-4.

Continuing to reference FIG. 5, step 525 of method 500 includes receiving, by a graphical user interface (GUI), the user interface data structure. This may be implemented, without limitation, as described above in reference to FIGS. 1-4.

Continuing to reference FIG. 5, step 530 of method 500 includes displaying, by the GUI, the at least one distinct routine on a first portion of the GUI. This may be implemented, without limitation, as described above in reference to FIGS. 1-4.

Continuing to reference FIG. 5, the method 500 may further comprise receiving, by the GUI, a user input for a selection of at least one of the at least one distinct routine. Additionally, or alternatively, the method 500 may further include displaying, by the GUI, the functional model on a second portion of the GUI. These may be implemented, without limitation, as described above in reference to FIGS. 1-4.

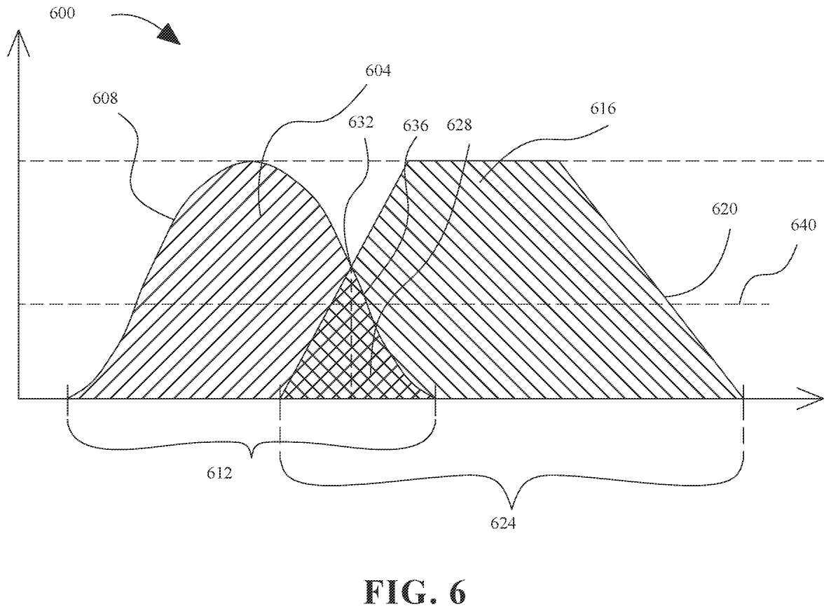

Referring now to FIG. 6, an exemplary embodiment of fuzzy set comparison 600 is illustrated. A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

With continued reference to FIG. 6, first fuzzy set 604 may represent any value or combination of values as described above, including output from one or more machine-learning models. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 628 that overlaps, first membership function 608 and second membership function 620 may intersect at a point 662 representing a probability, as defined on probability interval, of a match between first fuzzy set 604 and second fuzzy set 616. Alternatively, or additionally, a single value of first and/or second fuzzy set may be located at a locus 666 on first range 612 and/or second range 624, where a probability of membership may be taken by evaluation of first membership function 608 and/or second membership function 620 at that range point. A probability at 628 and/or 662 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, threshold may indicate a sufficient degree of overlap between an output from one or more machine-learning models, for combination to occur as described above. Alternatively, or additionally, each threshold may be tuned by a machine-learning and/or statistical process, for instance and without limitation as described in further detail below.

Further referring to FIG. 6, in an embodiment, a degree of match between fuzzy sets may be used to identify at least one institutional cohort for the entity. For example, if entity has a fuzzy set matching a candidate institutional cohort fuzzy set by having a degree of overlap exceeding a threshold, processor 104 may determine the candidate institutional cohort as one of the at least one institutional cohort. Where multiple fuzzy matches are performed, degrees of match for each respective fuzzy set may be computed and aggregated through, for instance, addition, averaging, or the like, to determine an overall degree of match.

With continued reference to FIG. 6, in an embodiment, data about the entity may be compared to multiple candidate institutional cohort fuzzy sets. For instance, entity data, as described above, may be represented by a fuzzy set that is compared to each of the multiple institutional cohort fuzzy sets; and a degree of overlap exceeding a threshold between the entity data fuzzy set and any of the multiple institutional cohort fuzzy sets may cause processor 104 to identify each of the multiple institutional cohorts associated with the fuzzy sets as institutional cohorts of the at least one institutional cohort. For instance, in one embodiment there may be two institutional cohort fuzzy sets, representing respectively a first institutional cohort and a second institutional cohort. A first institutional cohort may have a first fuzzy set; second institutional cohorts may have a second fuzzy set; and entity data may have an entity data fuzzy set. Processor 104, for example, may compare the entity data fuzzy set with each of first institutional cohort fuzzy set and second institutional cohort fuzzy set, as described above, and identify either, both, or neither of first and second institutional cohorts as the at least one institutional cohort to the entity. Machine-learning methods as described throughout may, in a non-limiting example, generate coefficients used in fuzzy set equations as described above, such as without limitation x, c, and σ of a Gaussian set as described above, as outputs of machine-learning methods. Likewise, user response may be used indirectly to determine a fuzzy set, as user response fuzzy set may be derived from outputs of one or more machine-learning models that take the user response directly or indirectly as inputs.

With continued reference to FIG. 6, a computing device may use a logic comparison program, such as, but not limited to, a fuzzy logic model to determine a compatibility score. A compatibility score may include, but is not limited to, high compatibility, mid compatibility, low compatibility, and the like; each such score may be represented as a value for a linguistic variable representing score, or in other words a fuzzy set as described above that corresponds to a degree of match of institutional cohort as calculated using any statistical, machine-learning, or other method that may occur to a person skilled in the art upon reviewing the entirety of this disclosure. In other words, a given element of entity data may have a first non-zero value for membership in a first linguistic variable value such as a first institutional cohort and a second non-zero value for membership in a second linguistic variable value such as a second institutional cohort. In some embodiments, identifying at least one institutional cohort may include using a linear regression model. A linear regression model may include a machine learning model. A linear regression model may be configured to map entity data to one or more institutional cohort data. A linear regression model may be trained using training data as discussed above. In some embodiments, identifying at least one institutional cohort may include using an institutional cohort classification model. An institutional cohort classification model may be configured to input collected data and cluster data to a centroid based on, but not limited to, frequency of appearance, and the like. Centroids may include compatibility scores assigned to them such that each cyber profile and risk profile may each be assigned a compatibility score. In some embodiments, an urgency classification model may include a K-means clustering model. In some embodiments, an urgency classification model may include a particle swarm optimization model. In some embodiments, determining a compatibility score of user response may user response using a fuzzy inference engine. A fuzzy inference engine may be configured to map one or more data elements using fuzzy logic. In some embodiments, a plurality of institutional cohorts may be arranged by a logic comparison program into compatibility score arrangements. An “compatibility score arrangement” as used in this disclosure is any grouping of objects and/or databased on degree of match for institutional cohort. This step may be implemented as described above in FIGS. 1-5. Membership function coefficients and/or constants as described above may be tuned according to classification and/or clustering algorithms. For instance, and without limitation, a clustering algorithm may determine a Gaussian or other distribution of questions about a centroid corresponding to a given level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 6, an inference engine may be implemented according to input and/or output membership functions and/or linguistic variables. Continuing the example, an output linguistic variable may represent, without limitation, a first institutional cohort. An inference engine may combine rules, such as: “if the degree of similarity is ‘low’ and the variability level is ‘low’, the degree of match is ‘high’”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤ T(c, d) if a≤ c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥” such as max(a, b), probabilistic sum of a and b (a+b−a*b), bounded sum, and/or drastic T-conorm; any T-conorm may be used that satisfies the properties of commutativity: ⊥(a, b)=1 (b, a), monotonicity: ⊥(a, b)≤⊥(c, d) if a≤c and b≤d, associativity: ⊥(a, ⊥(b, c))=⊥(⊥(a, b), c), and identity element of 0. Alternatively, or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively, or additionally, output rules may be replaced with functions according to the Takagi-Sugeno-King (TSK) fuzzy model.

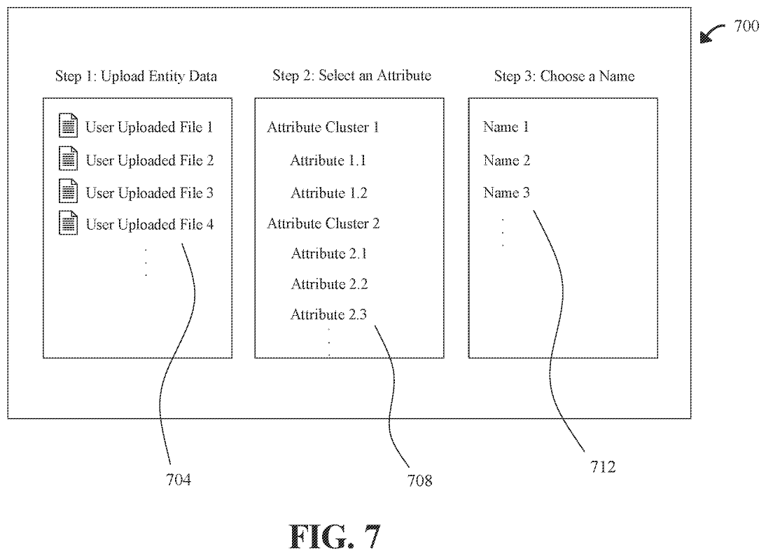

Now referring to FIG. 7, a non-limiting example of one or more GUI elements is illustrated. In some embodiments, GUI 700, and/or one or more elements of GUI 700 may be displayed on a user device, external remote device 120, or the like. GUI elements may include, without limitation, an entity data field 704 for inputting entity data 112, an attribute field 708 for selecting an attribute 168 and/or attribute cluster 708, and a name field 712 displaying one or more distinct names 164 or candidate names 712 determined by apparatus 100. In some embodiments, processor 104 may transmit to a user device, external remote device 120, or the like a data structure that configures the user device to display GUI 700 and/or one or more elements of GUI 700; in some embodiments, such a data structure may include a visual element data structure. GUI 700 disclosed herein may be consistent with GUI 188.

Still referring to FIG. 7, in some embodiments, GUI 700 may include entity data field 704 for inputting entity data 112. In some embodiments, entity data field 704 may accept user or entity inputs of entity data 112 in the form of files, such as text files. In some embodiments, a user or entity may “drag and drop” a file into entity data field 704 in order to upload the file. In some embodiments, a user may directly input entity data 112 into entity data field 704, such as by pasting text into the field. In some embodiments, entity data 112 may be input into entity data field 704.

Still referring to FIG. 7, in some embodiments, GUI 700 may include attribute field 708 for selecting an attribute 168 and/or attribute cluster. In some embodiments, the contents of attribute field 708 may be automatically generated and displayed to a user in attribute field 708 as a function of entity data 112 input into entity data field 704. In some embodiments, attribute field 708 may include attributes and/or attribute clusters associated with entity data 112. In some embodiments, attributes in attribute field 708 are organized by attribute cluster. In some embodiments, a user or entity may select an item in attribute field 708 by clicking on it. In some embodiments, a user selection of an item in attribute field 708 may cause it to become highlighted. In some embodiments, items automatically populated into attribute field 708 may be ordered according to a measure of their uniqueness in comparison to attributes 168 and/or attribute clusters of other entities.

Still referring to FIG. 7, in some embodiments, GUI 700 may include a field displaying one or more name field 712. In some embodiments, apparatus 100 may populate name field 712 as a function of a selection of an attribute and/or attribute cluster by a user in attribute field 708. In some embodiments, intelligibility rating 176, appeal rating 180, or both, are displayed such that they are associated with a distinct name or candidate name in name field 712.

Still referring to FIG. 7, in some embodiments, a computing device may display and/or configure a user device to display GUI 700 and/or may display and/or configure a user device to display a change in GUI 700 as a result of an event. In some embodiments, a computing device displaying and/or configuring a user device to display GUI 700 may produce a signal when an event occurs, and the computing device may modify GUI 700 as a result of the signal. Events may include, in non-limiting examples, a user hovering the cursor over an element, a user clicking on an element, a user pressing a key on a keyboard, a video ending, a user scrolling a mouse wheel, an error occurring, and the like. In some embodiment, a computing device may include event handler code that runs when an event occurs, causing a change in GUI 700. As non-limiting examples, events may result in a request being sent to an API, playing an animation, copying data to the clipboard, and entering full screen mode. As a non-limiting example, an event may include clicking on an attribute in field 708, and this may cause event handler code to cause the computing device to identify one or more names associated with that attribute, and display them in field 712.

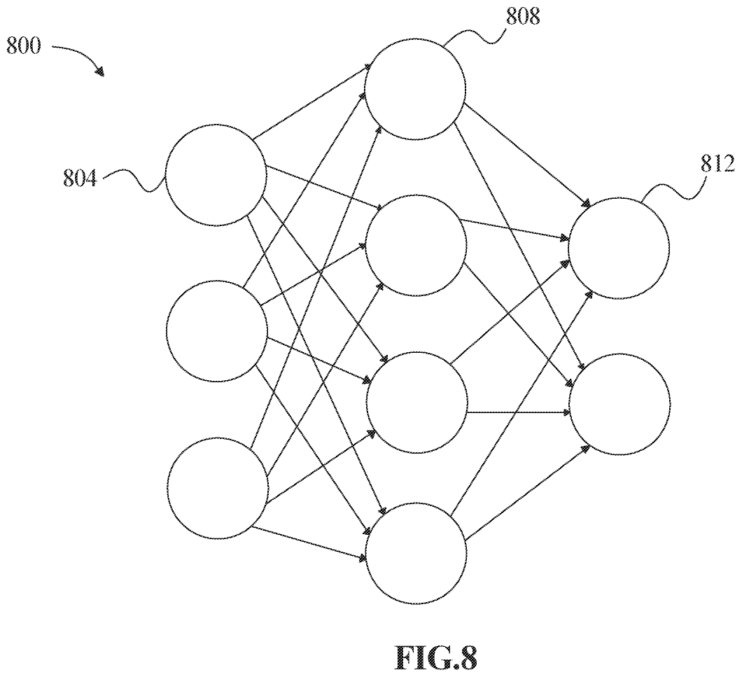

Referring now to FIG. 8, an exemplary embodiment of neural network 800 is illustrated. A neural network 800 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 804, one or more intermediate layers 808, and an output layer of nodes 812. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

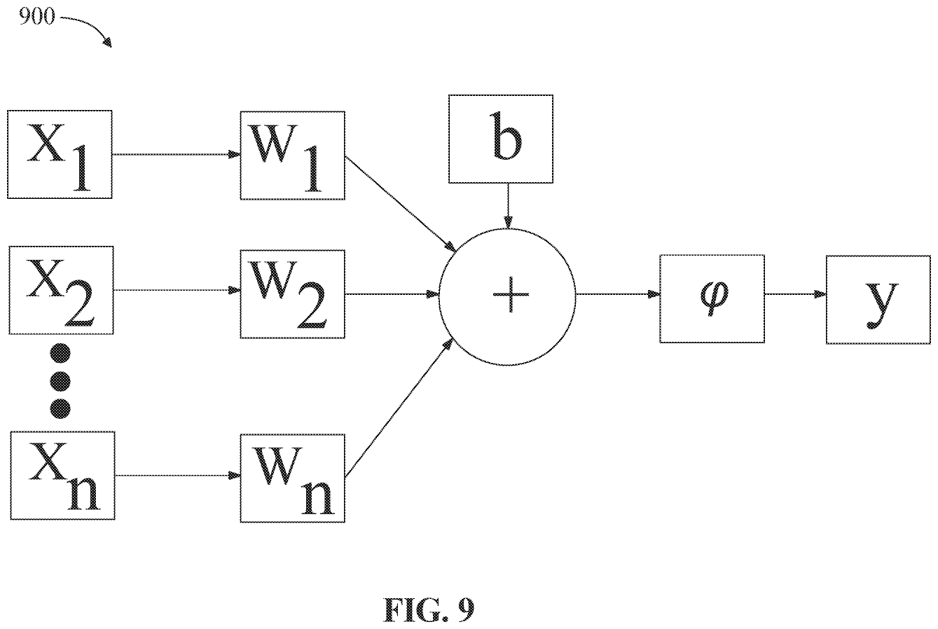

Referring now to FIG. 9, an exemplary embodiment of a node 900 of a neural network is illustrated. A node may include, without limitation, a plurality of inputs x; that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max(0,x), a “leaky” and/or “parametric” rectified linear unit function such as f(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of a (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh(\sqrt{2/τ}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

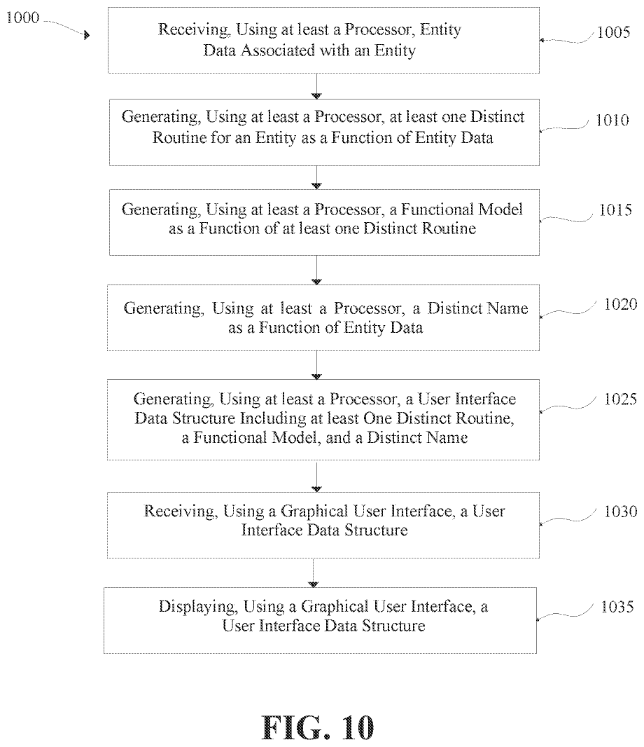

Referring now to FIG. 10, a flow diagram of an exemplary method 1000 for intelligently determining and implementing distinct routines for entities is illustrated. Method 1000 includes a step 1005 of receiving, using at least a processor, entity data associated with an entity. This may be implemented as reference to FIGS. 1-9.

With continued reference to FIG. 10, method 1000 includes a step 1010 of generating, using at least a processor, at least one distinct routine for an entity as a function of entity data. In some embodiments, method 1000 may further include determining, using the at least a processor, the at least one distinct routine based on a frequency of occurrence of a particular routine within the entity data. In some embodiments, method 1000 may further include calculating, using the at least a processor, a distance metric between each distinct routine of the at least one distinct routine and each institutional routine of at least one institutional routine and determining, using the at least a processor, the at least one distinct routine as a function of the distance metric. These may be implemented as reference to FIGS. 1-9.

With continued reference to FIG. 10, method 1000 includes a step 1015 of generating, using at least a processor, a functional model as a function of at least one distinct routine. This may be implemented as reference to FIGS. 1-9.

With continued reference to FIG. 10, method 1000 includes a step 1020 of generating, using at least a processor, a distinct name as a function of entity data, wherein generating the distinct name includes identifying a plurality of attributes of the entity data, determining a component word set as a function of the plurality of attributes and generating the distinct name as a function of the component word set. In some embodiments, method 1000 may further include generating, using the at least a processor, attribute training data, wherein the attribute training data may include correlations between exemplary entity data and exemplary attributes, training, using the at least a processor, an attribute classifier using the attribute training data, and identifying, using the at least a processor, the plurality of attributes using the trained attribute classifier. In some embodiments, method 1000 may further include generating, using the at least a processor, cohort training data, wherein the cohort training data may include correlations between exemplary entity data and exemplary entity cohorts, training, using the at least a processor, a cohort classifier using the cohort training data, and classifying, using the at least a processor, the entity data into one or more entity cohorts using the trained cohort classifier. In some embodiments, method 1000 may further include determining, using the at least a processor, the plurality of attributes as a function of the one or more entity cohorts. In some embodiments, method 1000 may further include determining, using the at least a processor, at least a candidate name as a function of the component word set, and determining, using the at least a processor, the distinct name as a function of the at least a candidate name. In some embodiments, method 1000 may further include generating, using the at least a processor, component word combination training data, wherein the component word combination training data may include correlations between exemplary component words and exemplary candidate names, training, using the at least a processor, a component word combination machine learning model using the component word combination training data, and determining, using the at least a processor, the at least a candidate name using the trained component word combination machine learning model. In some embodiments, method 1000 may further include generating, using the at least a processor, intelligibility rating training data, wherein the intelligibility rating training data may include correlations between exemplary component words and exemplary intelligibility ratings, training, using the at least a processor, an intelligibility rating machine learning model using the intelligibility rating training data and determining, using the at least a processor, the distinct name using the trained intelligibility rating machine learning model. In some embodiments, method 1000 may further include generating, using the at least a processor, appeal rating training data, wherein the appeal rating training data may include correlations between exemplary component words and exemplary appeal ratings, training, using the at least a processor, an appeal rating machine learning model using the appeal rating training data and determining, using the at least a processor, the distinct name using the trained appeal rating machine learning model. These may be implemented as reference to FIGS. 1-9.

With continued reference to FIG. 10, method 1000 includes a step 1025 of generating, using at least a processor, a user interface data structure including at least one distinct routine, a functional model, and a distinct name. This may be implemented as reference to FIGS. 1-9.

With continued reference to FIG. 10, method 1000 includes a step 1030 of receiving, using a graphical user interface (GUI) communicatively connected to at least a processor, a user interface data structure. This may be implemented as reference to FIGS. 1-9.

With continued reference to FIG. 10, method 1000 includes a step 1035 of displaying, using a GUI, a user interface data structure on the GUI. This may be implemented as reference to FIGS. 1-9.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 13114 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve apparatuses and methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for intelligently determining and implementing distinct routines for entities, the apparatus comprising:
at least a processor;
a memory communicatively coupled to the at least a processor, the memory containing instructions configuring the at least a processor to:
receive entity data associated with an entity;
generate at least one distinct routine for the entity as a function of the entity data;
generate a functional model as a function of the at least one distinct routine;
generate a distinct name as a function of the entity data, wherein generating the distinct name comprises:
identifying a plurality of attributes of the entity data;
determining a component word set as a function of the plurality of attributes; and
generating the distinct name as a function of the component word set; and
generate a user interface data structure comprising the at least one distinct routine, the functional model, and the distinct name; and
a graphical user interface (GUI) communicatively connected to the at least a processor, the GUI configured to:
receive the user interface data structure; and
display the user interface data structure.

2. The apparatus of claim 1, wherein the memory contains instructions further configuring the at least a processor to determine the at least one distinct routine based on a frequency of occurrence of a particular routine within the entity data.

3. The apparatus of claim 1, wherein the memory contains instructions further configuring the at least a processor to:
calculate a distance metric between each distinct routine of the at least one distinct routine and each institutional routine of at least one institutional routine; and
determine the at least one distinct routine as a function of the distance metric.

4. The apparatus of claim 1, wherein the memory contains instructions further configuring the at least a processor to:
generate attribute training data, wherein the attribute training data comprises correlations between exemplary entity data and exemplary attributes;
train an attribute classifier using the attribute training data; and
identify the plurality of attributes using the trained attribute classifier.

5. The apparatus of claim 1, wherein the memory contains instructions further configuring the at least a processor to:
generate cohort training data, wherein the cohort training data comprises correlations between exemplary entity data and exemplary entity cohorts;
train a cohort classifier using the cohort training data; and
classify the entity data into one or more entity cohorts using the trained cohort classifier.

6. The apparatus of claim 5, wherein the memory contains instructions further configuring the at least a processor to determine the plurality of attributes as a function of the one or more entity cohorts.

7. The apparatus of claim 1, wherein the memory contains instructions further configuring the at least a processor to:
determine at least a candidate name as a function of the component word set; and
determine the distinct name as a function of the at least a candidate name.

8. The apparatus of claim 7, wherein the memory contains instructions further configuring the at least a processor to:
generate component word combination training data, wherein the component word combination training data comprises correlations between exemplary component words and exemplary candidate names;
train a component word combination machine learning model using the component word combination training data; and
determine the at least a candidate name using the trained component word combination machine learning model.

9. The apparatus of claim 1, wherein the memory contains instructions further configuring the at least a processor to:
generate intelligibility rating training data, wherein the intelligibility rating training data comprises correlations between exemplary component words and exemplary intelligibility ratings;
train an intelligibility rating machine learning model using the intelligibility rating training data; and
determine the distinct name using the trained intelligibility rating machine learning model.

10. The apparatus of claim 1, wherein the memory contains instructions further configuring the at least a processor to:
generate appeal rating training data, wherein the appeal rating training data comprises correlations between exemplary component words and exemplary appeal ratings;
train an appeal rating machine learning model using the appeal rating training data; and
determine the distinct name using the trained appeal rating machine learning model.

11. A method for intelligently determining and implementing distinct routines for entities, the method comprising:
receiving, using at least a processor, entity data associated with an entity;
generating, using the at least a processor, at least one distinct routine for the entity as a function of the entity data;
generating, using the at least a processor, a functional model as a function of the at least one distinct routine;
generating, using the at least a processor, a distinct name as a function of the entity data, wherein generating the distinct name comprises:
identifying a plurality of attributes of the entity data;
determining a component word set as a function of the plurality of attributes; and
generating the distinct name as a function of the component word set;
generating, using the at least a processor, a user interface data structure comprising the at least one distinct routine, the functional model, and the distinct name;
receiving, using a graphical user interface (GUI) communicatively connected to the at least a processor, the user interface data structure; and
displaying, using the GUI, the user interface data structure.

12. The method of claim 11, further comprising:
determining, using the at least a processor, the at least one distinct routine based on a frequency of occurrence of a particular routine within the entity data.

13. The method of claim 11, further comprising:
calculating, using the at least a processor, a distance metric between each distinct routine of the at least one distinct routine and each institutional routine of at least one institutional routine; and
determining, using the at least a processor, the at least one distinct routine as a function of the distance metric.

14. The method of claim 11, further comprising:
generating, using the at least a processor, attribute training data, wherein the attribute training data comprises correlations between exemplary entity data and exemplary attributes;
training, using the at least a processor, an attribute classifier using the attribute training data; and
identifying, using the at least a processor, the plurality of attributes using the trained attribute classifier.

15. The method of claim 11, further comprising:
generating, using the at least a processor, cohort training data, wherein the cohort training data comprises correlations between exemplary entity data and exemplary entity cohorts;
training, using the at least a processor, a cohort classifier using the cohort training data; and
classifying, using the at least a processor, the entity data into one or more entity cohorts using the trained cohort classifier.

16. The method of claim 15, further comprising:
determining, using the at least a processor, the plurality of attributes as a function of the one or more entity cohorts.

17. The method of claim 11, further comprising:
determining, using the at least a processor, at least a candidate name as a function of the component word set; and
determining, using the at least a processor, the distinct name as a function of the at least a candidate name.

18. The method of claim 17, further comprising:
generating, using the at least a processor, component word combination training data, wherein the component word combination training data comprises correlations between exemplary component words and exemplary candidate names;
training, using the at least a processor, a component word combination machine learning model using the component word combination training data; and
determining, using the at least a processor, the at least a candidate name using the trained component word combination machine learning model.

19. The method of claim 11, further comprising:
generating, using the at least a processor, intelligibility rating training data, wherein the intelligibility rating training data comprises correlations between exemplary component words and exemplary intelligibility ratings;
training, using the at least a processor, an intelligibility rating machine learning model using the intelligibility rating training data; and
determining, using the at least a processor, the distinct name using the trained intelligibility rating machine learning model.

20. The method of claim 11, further comprising:
generating, using the at least a processor, appeal rating training data, wherein the appeal rating training data comprises correlations between exemplary component words and exemplary appeal ratings;
training, using the at least a processor, an appeal rating machine learning model using the appeal rating training data; and
determining, using the at least a processor, the distinct name using the trained appeal rating machine learning model.
